(19) United States
(12) Patent Application Publication
(10) Pub. No.: US 2021/0318277 A1
(43) Pub. Date: Oct. 14, 2021

(54) ANALYSIS METHOD, ANALYSIS APPARATUS, ANALYSIS PROGRAM, METHOD FOR GENERATING STANDARD SHAPE

(71) Applicant: KAGAMI INC., Osaka (JP)

(72) Inventors: Tatsuhiko IKEDA, Tokyo (JP); Masashi MlTA, Tokyo (JP)

(21) Appl. No.: 17/283,716

(22) PCT Filed: Oct. 11, 2019
(86) PCT No.: PCT/JP2019/040289

§ 371 Date: Apr. 8, 2021

(30) Foreign Application Priority Data
Oct. 11, 2018 (JP) 2018-192980

(51) Int. Cl. G01N 30/86; G01N 30/74; G06T 7/00; G06T 7/50

(52) U.S. Cl. CPC G01N 30/8675; G01N 30/74; G01N 2030/027; G06T 7/50; G06T 7/001

(57) ABSTRACT

An analysis method for data generated by at least two parameters is provided. The method includes a comparison step of making a comparison between a data shape of a target component in a measurement sample and a standard shape acquired in advance, and a step of identifying the target component in the measurement sample based on the comparison.

### TECHNICAL FIELD

The present invention relates to an analysis method, an analysis apparatus, an analysis program, and a method for generating a standard shape.

### BACKGROUND ART

In the field of chemical analysis, it is known that a given component in a sample is identified and quantified by obtaining data that includes two or more parameters for the given component and analyzing the data. For example, in chromatography, a sample is separated into components based on time, space, and mass, the separated components are detected by a detector, and the signal intensity obtained from the detector is recorded at each point in time. In this manner, data (such as a chromatogram) that mainly includes two parameters, time and signal strength, can be obtained. Then, a target component can be identified and quantified based on the magnitude of a quantitative parameter (such as the magnitude of a peak in the chromatogram).

In quantitative analysis as described above, it is necessary to set a reference for determining the magnitude of a parameter for a target component. For example, in the chromatogram described above, it is necessary to set a baseline for determining the height and the area of a peak of the target component. However, the peak of the target component is not necessarily independent (separated) in the data. Thus, it may be difficult to determine the magnitude of the parameter due to effects from other adjacent components. Therefore, methods for quantifying components based on data including non-separated peaks have been investigated. For example, Non-Patent Document 1 describes quantitative methods based on non-separated peaks in chromatograms.

### RELATED-ART DOCUMENTS

### Non-Patent Documents

Non-Patent Document 1: “Ekikuro inu no maki” supervised by Hiroshi Nakamura, edited by the division of liquid chromatography of the Japan Society for Analytical Chemistry, published on Feb. 2, 2006, pages 96-97

### SUMMARY OF THE INVENTION

### Problem to be Solved by the Invention

However, as described in Non-Patent Document 1, there is no established method for performing quantification based on data including non-separated peaks. Therefore, data of a target component may be unable to be appropriately analyzed, and securing a reliable quantitative value may be difficult, thus making it difficult to perform a highly reliable analysis.

In view of the above, an aspect of the present invention provides a data analysis method capable of performing a more reliable analysis.

### Means to Solve the Problem

According to an aspect of the present invention, an analysis method for data generated by at least two parameters is provided. The method includes a comparison step of making a comparison between a data shape of a target component in a measurement sample and a standard shape acquired in advance, and a step of identifying the target component in the measurement sample based on the comparison.

Further, according to an aspect of the present invention, an analysis method for data generated by at least two parameters is provided. The method includes a comparison step of making a comparison between a data shape of a target component in a measurement sample and a standard shape acquired in advance, and a quantitative value calculation step of calculating a quantitative value of the target component in the measurement sample based on the comparison. The standard shape includes a group of shapes of the target component acquired from a plurality of standard samples containing the target component at different quantitative values.

### Effects of the Invention

According to an aspect of the present invention, a data analysis method capable of performing a more reliable analysis is provided.

### BRIEF DESCRIPTION OF THE DRAWINGS

FIG. 1 is a diagram illustrating characteristics of data shapes;

FIG. 2 is a diagram illustrating an example of a functional configuration of an analysis apparatus according to an embodiment of the present invention;

FIG. 3 is a diagram illustrating an example of a hardware configuration of the analysis apparatus according to an embodiment of the present invention;

FIG. 4 is a flowchart of a process for generating calibration data in an analysis method according to an embodiment of the present invention;

FIG. 5 is a diagram illustrating an example of the relationship between the quantitative value (concentration) and the representative standard shape;

FIG. 6 is a flowchart of a quantitation process in the analysis method according to an embodiment of the present invention;

FIG. 7 is a flowchart illustrating details of a comparison procedure in the analysis method according to an embodiment of the present invention;

FIG. 8 is a diagram illustrating the generation of partial shapes;

FIG. 9 is a diagram illustrating an example of three-dimensional data;

FIG. 9a is a flowchart illustrating a variation of the analysis method according to an embodiment of the present invention;

FIG. 10 is a diagram illustrating data in Example 1;

FIG. 11 is a diagram illustrating data in Example 2;

FIG. 12 is a diagram illustrating data in Example 3;

FIG. 13 is a flowchart illustrating details of the calibration data generation process in the examples;

FIG. 14 is a flowchart illustrating details of the quantification process in the examples;

FIG. 15A illustrates a quality check sheet for analytical conditions of a blood sample according to example 4;

FIG. 15B illustrates a quality check sheet for analytical conditions of the blood sample according to example 4;

FIG. 16A illustrates a quality check sheet for the analytical conditions of a urine sample according to example 4;

FIG. 16B illustrates a quality check sheet for the analytical conditions of the urine sample according to example 4;

FIG. 17A illustrates results of shape fitting for blood samples according to example 4;

FIG. 17B illustrates results of shape fitting for blood samples according to example 4;

FIG. 17C illustrates results of shape fitting for blood samples according to example 4;

FIG. 17D illustrates results of shape fitting for blood samples according to example 4;

FIG. 17E illustrates results of shape fitting for blood samples according to example 4;

FIG. 17F illustrates results of shape fitting for blood samples according to example 4;

FIG. 17G illustrates results of shape fitting for blood samples according to example 4;

FIG. 17H illustrates results of shape fitting for blood samples according to example 4;

FIG. 18A illustrates results of shape fitting for urine samples according to example 4;

FIG. 18B illustrates results of shape fitting for urine samples according to example 4;

FIG. 18C illustrates results of shape fitting for urine samples according to example 4;

FIG. 18D illustrates results of shape fitting for urine samples according to example 4;

FIG. 18E illustrates results of shape fitting for urine samples according to example 4; and

FIG. 18F illustrates results of shape fitting for urine samples according to example 4.

### MODE FOR CARRYING OUT THE INVENTION

According to an aspect of the present invention, an analysis method for data generated by at least two parameters is provided. The method includes a comparison step of making a comparison between a data shape of a target component in a measurement sample and a standard shape acquired in advance, and a step of identifying the target component in the measurement sample based on the comparison.

Further, according to an aspect of the present invention, an analysis method for data generated by at least two parameters is provided. The method includes a comparison step of making a comparison between a data shape of a target component in a measurement sample and a standard shape acquired in advance, and a quantitative value calculation step of calculating a quantitative value of the target component in the measurement sample based on the comparison. The standard shape includes a group of shapes of the target component acquired from a plurality of standard samples containing the target component at different quantitative values.

Further, according to an aspect of the present invention, a method for generating a standard shape for use in an analysis of data represented by at least two parameters is provided. The standard shape includes a group of shapes of a target component acquired from a plurality of standard samples containing a target component at different quantitative values.

As used herein, the term “data shape” or “shape” refers to the shape of data that represents features of a component in a sample by using two or more parameters, or that may represent a function by using two or more parameters. The “data shape” is not limited to a shape in a physical space such as a two-dimensional space (plane) or a three-dimensional space. The “data shape” is a concept that can be extended to a shape in a four or more dimensional space. In order to calculate the quantitative value of a target component, at least one of parameters used is a quantitative parameter for the target component.

In the following, embodiments of the present invention will be described, mainly based on separation analysis data that includes two parameters, and more specifically based on data that represents the signal intensity with respect to time (that is, data that represents the time-series signal intensity); however, the present invention is not limited to specific embodiments described herein.

### <Data Shape>

As a result of earnest investigations on the shape of separation analysis data generated by at least two parameters, the inventors of the present invention found that, if data shapes of a target component obtained under the same conditions are extended in one direction (specifically, the quantitative parameter axis direction) at a predetermined magnification, the data shapes become the same.

The above-described findings will be described based on a chromatogram as an example. A chromatogram is data (a graph or a chart) obtained by chromatography that temporally separates components of a sample and generated by two parameters, time and signal intensity detected by a detector. Of the two parameters of the chromatogram, the signal intensity is a parameter that reflects the amount of a target component, namely a quantitative parameter. The time is a parameter that does not reflect the amount of the target component, namely a non-quantitative parameter.

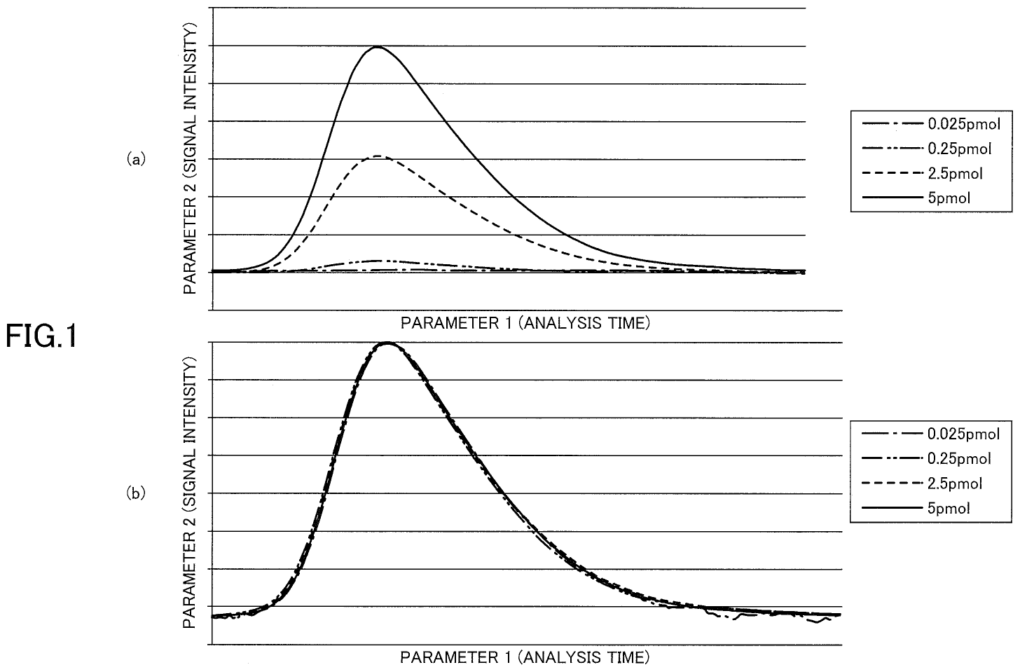

FIG. 1(a) illustrates a part of a chromatogram obtained by analyzing samples including D-asparagine with high-performance liquid chromatography. Pieces of data (peaks) in FIG. 1 (a) are obtained from the samples including different concentrations of D-asparagine and are analyzed under the same analytical conditions (the concentrations of D-asparagine are 0.025 pmol/inj, 0.25 pmol/inj, 2.5 pmol/inj, and 5.0 pmol/inj). In the chromatogram illustrated in FIG. 1(a), the horizontal axis indicates the retention time and the vertical axis indicates the signal strength.

FIG. 1(b) illustrates an example in which the magnifications in the vertical axis (intensity axis) direction of the peaks illustrated in FIG. 1 (a) are changed such that the intensities at peak tops (peak heights) become the same. More specifically, the peaks of 0.025 pmol/inj, 0.25 pmol/inj, and 2.5 pmol/inj are magnified in the intensity axis direction, such that the intensities at the tops of the peaks of 0.025 pmol/inj, 0.25 pmol/inj, and 2.5 pmol/inj become the same as the intensity at the top of the peak of 5 pmol/inj. Note that, in the example of FIG. 1(b), the peaks are shifted in the intensity axis direction such that the intensities (values of the vertical axis) at the peak tops become zero.

As illustrated in FIG. 1(b), it can be seen that all the peaks overlap each other by the changes in the magnifications in the intensity axis direction (the shapes of all the peaks are approximately the same). As used herein, the terms “substantially the same” and “approximately the same” include a case where there is a deviation due to mechanical, electrical, or human error at the time of measurement. Further, as used herein, the term “same analytical conditions” or “same analysis system” means that, if chromatography is used, analytical conditions, such as the size and shape of a column, a filler, a stationary phase, a mobile phase, a carrier type, a delivery method, and temperature, are substantially the same.

Accordingly, it can be seen that data shapes of a given component obtained under the same analytical conditions have characteristics specific to the given component.

As in the above-described chromatogram, the peaks of a given component obtained under the same analytical conditions have shapes specific (peculiar or unique) to the given component, except for concentration-dependent differences in the magnitudes (scales) in the intensity axis direction of the peaks. In other words, in a case where two peaks p_{A} and p_{B} are obtained from two respective samples including different concentrations of a given component under the same analytical conditions, and the two peaks p_{A} and p_{B} of the given component are compared, the ratio (ΔI_{A}/ΔI_{B}) of the amount of increase (ΔI_{A}) in the peak p_{A} to the amount of increase (ΔI_{B}) in the peak p_{B} within the same time range Δt is approximately constant. Alternatively, if tangent lines to the both peaks are drawn at the same position in the time axis direction, and the slopes of the tangent lines to the peaks are compared, the ratio of the two slopes is the same or substantially the same at any position in the time axis direction.

Accordingly, even if data of a target component is not separated (not independent), and overlaps with data of another adjacent component (contaminant), the target component can be identified (specified) as long as a data shape of the target component, not affected by the adjacent component, partially appears. Specifically, the target component can be identified (specified) by comparing a part of the data shape of the target component to a pre-acquired data shape (standard shape), which is preliminarily acquired from a known concentration of the target component. In addition, once the target component is identified (specified), the concentration of the target component can be estimated or quantified.

For example, in a chromatogram, a partial shape or the entire shape of a peak of a target component present in a measurement sample is caused to overlap with a shape (standard shape) of a standard peak, which is preliminarily acquired from a known concentration of the target component, such that the position in the time axis direction of the peak of the target component matches the position in the time axis direction of the standard peak. Then, the magnification (ratio of enlargement or reduction) in the signal intensity axis direction of the peak of the target component relative to the standard peak is obtained. In this manner, the target component can be identified (specified) based on the degree of overlap. In addition, the concentration of the target component can be predicted. For example, when the peak of the target component is caused to overlap with the standard peak, the position in the time axis direction of the peak top (the highest point of the shape) of the target component can be corrected to match the position in the time axis direction of the top of the standard peak. At this time, if each point in the intensity axis direction of the shape under the analysis conditions is specified as a probability density function, the intensity may be corrected according to the rate of correction in the time axis direction. For example, when the rate of change in the time axis direction is ΔT (the amount of time correction)/T (time before correction), the intensity can also be corrected based on the rate ΔT/T.

Further, based on the shapes (standard shapes) of a plurality of standard peaks, the relationship between the magnitudes in the intensity axis direction of the peaks and concentrations may be obtained and stored beforehand as a regression equation. Accordingly, the regression equation can be used as a calibration curve. By using the shape of at least one standard peak and the regression equation, the target component in the sample can be quantified.

Accordingly, in an embodiment of the present invention, the target component can be identified and quantified by overlapping and comparing the shape of the target component and a pre-acquired standard shape (shape fitting/shape scaling). Therefore, for example, in a chromatography analysis, a baseline for calculating a peak height or a peak area in a chromatogram is not required to be set. Thus, as compared to a conventional method in which human error may occur when setting a baseline, the reliability of a quantitative value obtained can be increased.

Note that, in general, if data that includes a completely separated target component can be obtained (for example, if the peak of the target component can be completely separated), it will be easy to identify and quantify the target component. However, it may be sometimes impractical to obtain data that includes a completely separated target component because the target component and other components may be chemically inseparable or it may require a significant amount of time. Conversely, an embodiment of the present invention can provide an effect of reducing analysis time. In addition, according to an embodiment of the present invention, even for data that includes a non-separated target component, which is difficult to be identified and quantified by conventional methods, such data can be analyzed as long as a part of the shape of the target component appears.

### <Example Configuration of Analysis Apparatus>

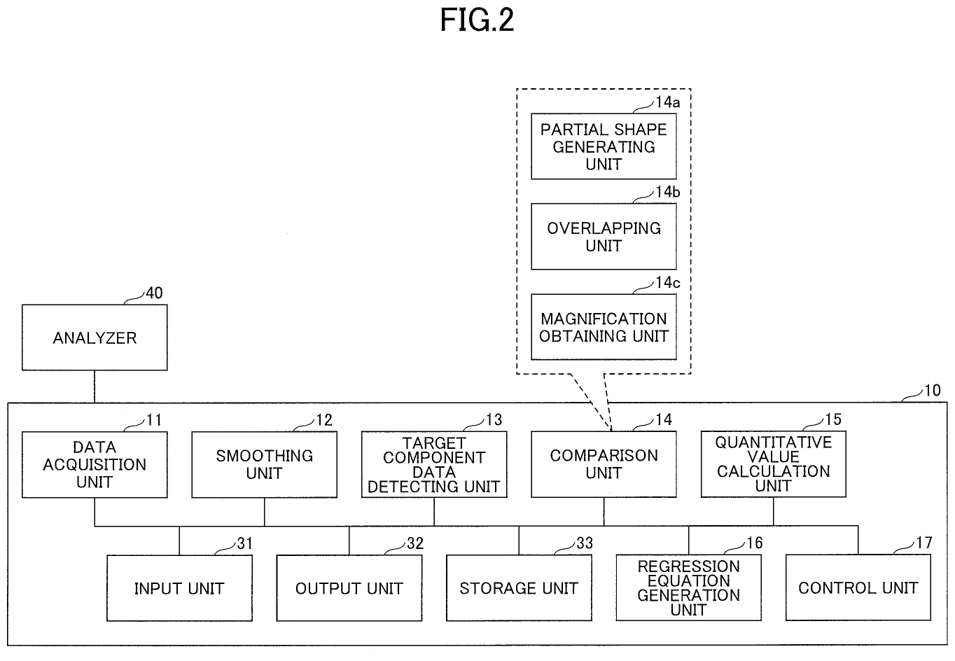

FIG. 2 is a diagram illustrating an example of a functional configuration of a waveform data analysis apparatus configured to perform an analysis method according to an embodiment of the present invention. As illustrated in FIG. 2, an analysis apparatus 10 includes an input unit 31, an output unit 32, a storage unit 33, a data acquisition unit 11, a smoothing unit 12, a target component data detecting unit 13, a comparison unit 14, a quantitative value calculation unit 15, a regression equation generation unit 16, and a control unit 17.

As illustrated in FIG. 2, the analysis apparatus 10 is connected to an analyzer 40. The analyzer 40 may be any chemical analysis apparatus capable of analyzing a sample and outputting quantitative data. For example, the analyzer 40 may utilize chromatography using a gas, a liquid, a supercritical fluid, or the like as the mobile phase; quadrupole mass spectrometry, double-focusing (magnetic field) mass spectrometry, time-of-flight mass spectrometry, ion trap mass spectrometry, an ion cyclotron resonance mass spectrometry, or the like; a spectroscopy using infrared, visible light, ultraviolet light, X-rays, fluorescence, or the like, or any combination thereof. The analyzer 40 may include a detector that can quantitatively detect components in a sample. The detector may be any detector that can detect a component and output an optical value or a mass value for the component.

The analysis apparatus 10 can compare a data shape (such as a peak shape) of a target component present in a measurement sample to a pre-acquired standard shape of the target component, identify the target component (an identification process), and calculate the quantitative value of the target component whose amount is unknown (a quantification process).

Further, the analysis apparatus 10 can generate calibration data such as a calibration curve for the above-described quantification process (a calibration data generation process). At this time, the analysis apparatus 10 acquires the shapes of a plurality of standard samples as standard shapes, and obtains a regression equation that represents the relationship between the quantitative values and the magnitudes of the standard shapes, as will be described later. At least one of the standard shapes and the regression equation can be used as calibration data (calibration curve data). Note that the standard shapes of the plurality of standard samples are not necessarily required to be separated.

The data acquisition unit 11 acquires data from the analyzer 40. The data may include two or more parameters obtained for one or more samples. One of the two or more parameters is a quantitative parameter indicating the amount of the target component. For example, the data may be waveform data representing the signal intensity with respect to time (time-series signal intensity). The signal intensity may indicate the amount of a component as an optical value or a mass value, depending on the type of the detector. Further, the data acquisition unit 11 may acquire a plurality of different signal intensities (quantitative parameters) from a plurality of analyzers or a plurality of detectors. Note that the data can be acquired from the analyzer 40 as image data, or the data acquisition unit 11 can generate image data.

The data acquisition unit 11 can acquire data of a sample (measurement sample) whose concentration is unknown, and can acquire data (calibrator data) for generating calibration data. Further, in addition to the above-described data, the data acquisition unit 11 can acquire data related to the sample and the target component (such as the retention time of the target component). In a calibration data generation process, the data acquisition unit 11 can acquire data related to the concentration of the target component. In addition, the data acquisition unit 11 acquires data of a quality control sample if quality control/quality evaluation is performed in the analysis method according to the embodiment.

The smoothing unit 12 performs a smoothing process in order to remove noise from data acquired as an image or the like. As the smoothing process, smoothing by polynomial fitting such as the Savitzky-Golay method is preferable. However, the smoothing process may use a simple average, a median, the maximum/minimum value, filtering such as opening/closing, edge-preserving smoothing, the K-nearest neighbors algorithm, a selective average method, or the like.

The target component data detecting unit 13 detects and extracts data of the target component from data that is acquired by the data acquisition unit 11 and that may include any other components. Specifically, the target component data detecting unit 13 detects and extracts data of the target component based on position information of the target component.

The comparison unit 14 compares a data shape of the target component in the acquired data. Specifically, in the identification process or the quantification process, the comparison unit 14 compares a data shape (which may be referred to as a measurement shape) of the target component of the measurement sample to a pre-acquired standard shape. At this time, the comparison unit 14 overlaps the measurement shape and the standard shape and compares the magnitudes of quantitative parameters. Further, the comparison unit 14 can also compare a plurality of standard shapes in the calibration data generation process. At this time, the plurality of standard shapes are not necessarily required to be separated.

As illustrated in FIG. 2, the comparison unit 14 may include a partial shape generating unit 14a, an overlapping unit 14b, and a magnification obtaining unit 14c.

The partial shape generating unit 14a generates a partial shape by dividing the measurement shape of the target component in the non-quantitative parameter axis direction (time axis direction). Therefore, the partial shape is a part of the measurement shape (data shape). The partial shape can be a shape that is a part of the data shape and that includes the highest point of the data shape. The above-described dividing process is included in a comparison procedure, which will be described later, of the quantification process in order to increase the accuracy of comparison.

The overlapping unit 14b can overlap the entire measurement shape or a part of the measurement shape as described above with a standard shape. Further, the overlapping unit 14b can overlap standard shapes with each other in the calibration data generation process. The overlapping unit 14b uses pre-acquired position information in the non-quantitative parameter axis direction (time axis direction) of the target component when overlapping the shapes.

The magnification obtaining unit 14c obtains the magnification, in the quantitative parameter axis direction (signal intensity axis direction), of a data shape with respect to another data shape at any position in the non-quantitative parameter axis direction (time axis direction). That is, in the quantification process, the magnification obtaining unit 14c can obtain the magnification of the measurement shape of the target component relative to a standard shape. Further, in the calibration data generation process, the magnification obtaining unit 14c can obtain the magnification of one standard shape relative to another standard shape. The magnification obtaining unit 14c can also obtain a representative magnification value based on magnifications obtained at respective positions in the time axis direction.

In the quantification process, the quantitative value calculation unit 15 substitutes the magnification value of the measurement shape, obtained by the magnification obtaining unit 14c of the comparison unit 14, into a regression equation of calibration data acquired in advance. Accordingly, a quantitative value can be calculated.

In the calibration data generation process, the regression equation generation unit 16 can generate a regression equation, indicating the relationship between the quantitative values and the magnitudes in the quantitative parameter axis direction of standard shapes, based on the standard shapes of a plurality of standard samples.

The input unit 31 receives inputs such as instructions to start and stop data analysis and other settings from a user who uses the analysis apparatus 10. Further, the user can use the input unit 31 to input instructions and settings while looking at an image displayed by the output unit 32, which will be described below.

The output unit 32 outputs the contents input by the input unit 31, the results executed based on the input contents, and the like. For example, the output unit 32 can output (display) data or an image acquired by the data acquisition unit 11. In addition, the output unit 32 outputs quality check results if the quality of the analytical conditions is evaluated in the analysis method according to the embodiment.

The storage unit 33 stores various types of information. Specifically, the storage unit 33 stores various types of programs and various types of settings necessary to perform an analysis process according to the embodiment. In addition to any data acquired by the data acquisition unit 11, the storage unit 33 can store data generated in the analysis apparatus 10, such as data of partial shapes and the magnifications in the quantitative parameter axis direction of standard shapes. Further, the storage unit 33 can store calibration data (such as standard shapes and a regression equation) generated by the calibration data generation process.

The control unit 17 controls the above-described units 11 through 16 and 31 through 33 of the analysis apparatus 10.

### <Hardware Configuration of Analysis Apparatus>

The above-described analysis apparatus 10 can perform an analysis process by generating an execution program (evaluation program), which enables a computer to execute functions, and installing the execution program (analysis program) in a general-purpose personal computer (PC).

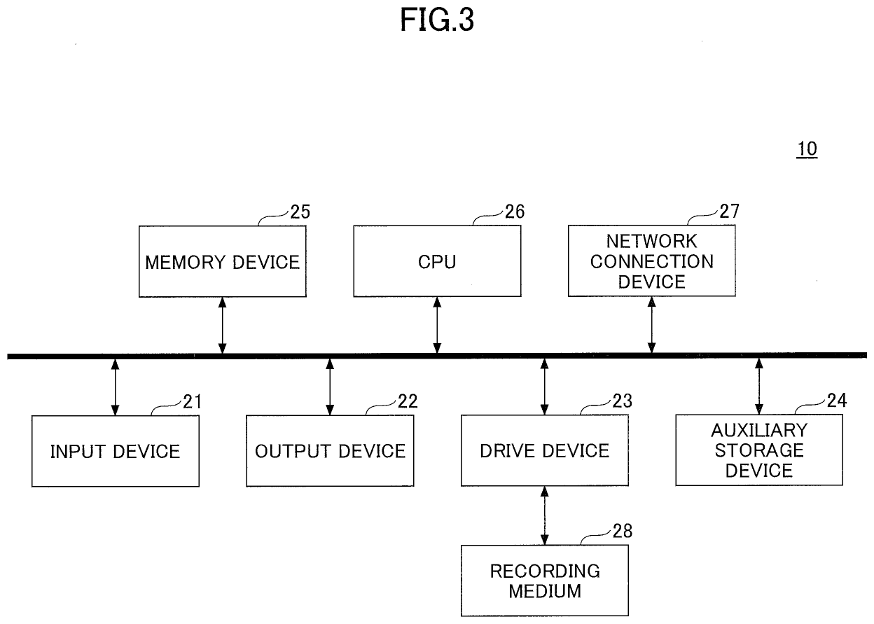

FIG. 3 is a diagram illustrating an example of a hardware configuration of a computer capable of executing the analysis process according to the present embodiment. The analysis apparatus 10 includes an input device 21, an output device 22, a drive device 23 , an auxiliary storage device 24, a memory device 25, a central processing unit (CPU) 26 that performs various kinds of control, and a network connection device 27, which are interconnected as a system.

The input device 41 may be a touch panel, a keyboard, and a pointing device, such as a mouse, that are operated by a user. Further, the input device 21 may be a voice input device such as a microphone capable of receiving voice input and the like.

The output device 42 may be a monitor, a display, a speaker, or the like. Further, the output device 22 may be a print device such as a printer.

The input device 21 and the output device 22 correspond to the above-described input unit 11 and the output unit 12. Further, the input device 21 and the output device 22 may be configured such that an input configuration and an output configuration are integrated, such as a smartphone or a table terminal.

In the present embodiment, the execution program to be installed in the analysis apparatus 10 is provided by way of a portable recording medium 28 such as a universal serial bus (USB) memory or a CD-ROM. The recording medium 28 may be loaded into the drive unit 43. The execution program included in the recording medium 28 is installed in the auxiliary storage device 24 from the recording medium 28 through the drive device 23.

The auxiliary storage device 24 is a storage unit such as a hard disk. The auxiliary storage device 24 can store the execution program according to the present embodiment, a control program installed in the computer, and the like, and can input and output such programs as necessary.

The memory device 25 stores the execution program and the like read from the auxiliary storage device 24 by the CPU 26. The memory device 25 may be a read-only memory (ROM), a random-access memory (RAM), or the like. The above-described auxiliary storage device 24 and the memory device 25 may be integrated into one storage device.

The CPU 26 implements the analysis process according to the present embodiment by controlling processes of the entire computer, such as various kinds of operations and data input/output into/from hardware components, based on a control program such as an operating system (OS) and the execution program stored in the memory device 25. Various kinds of information required during the execution of a program may be acquired from the auxiliary storage device 24, and the execution results may be stored in the auxiliary storage device 24 .

The network connection device 27 acquires the execution program and various kinds of data from another device connected to a communication network such as the Internet or a LAN by connecting to the communication network. Further, the network connection device 27 can provide other devices with execution results acquired by executing a program.

### <Data Analysis Method>

Next, a data analysis method according to an embodiment of the present invention will be described. The analysis method includes comparing a data shape (a measurement shape) of a target component to a pre-acquired standard shape of the same target component. Such pre-acquired standard shapes are included in calibration data and used for calculation of a quantitative value. Further, in addition to the standard shapes, a regression equation that represents the relationship between the quantitative values and the magnitudes in the quantitative parameter axis (intensity axis) of the standard shapes can be obtained beforehand.

Accordingly, the target component can be quantified based on the standard shapes and the regression equation (calibration data).

In the following, the generation of calibration data will be described first.

### (Calibration Data Generation Process)

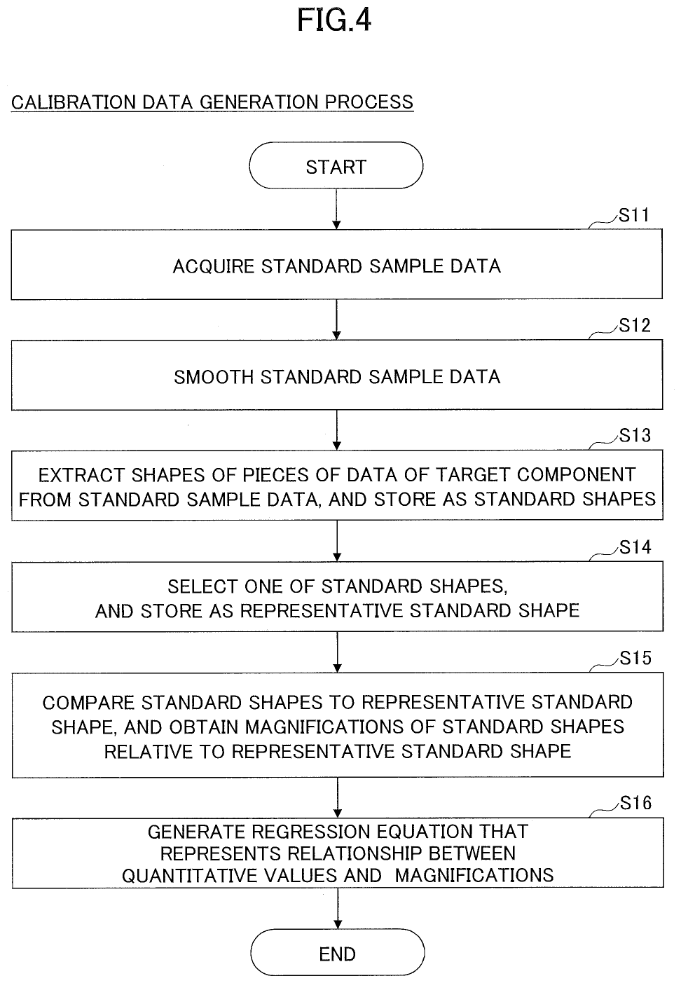

FIG. 4 is a flowchart of a process for generating calibration data (calibration data generation process). In the following example, data is represented by time, which is a non-quantitative parameter, and signal strength, which is a quantitative parameter. The calibration data may be acquired as a chart having a time axis and a signal intensity axis. In such a chart, a component can be identified by overlapping shapes based on position information in the time axis direction.

The data acquisition unit 11 of the analysis apparatus 10 acquires data (standard sample data) for generating calibration data (S11). The standard sample data is a plurality of pieces of data of samples that include a target component at different known amounts (such as at different known concentrations). The standard sample data may include other qualitative information on the target component, such as position formation (retention time formation) in the time axis direction of the target component. The standard sample data can be acquired directly from the analyzer 40 connected to the analysis apparatus 10. Note that the standard sample data prepared to quantify the target component includes different quantitative values (such as concentrations), and is acquired from the analyzer 40 under the same analytical conditions.

The smoothing unit 12 performs a smoothing process on each piece of the standard sample data acquired as image data (S12). The smoothing process is not particularly limited as described above, but the Savitzky-Golay method is preferably used. In this case, although the accuracy increases as the number of data points increases, the number of data points (values of N) used for smoothing is preferably 10 or more.

The target component data detecting unit 13 detects pieces of data of the target component from the respective pieces of the smoothed standard sample data, and extracts the shapes of the pieces of data of the target component as standard shapes. The storage unit 33 stores the standard shapes (S13). Note that pre-acquired position information in the time axis direction can be used to detect the pieces of data of the target component.

Further, one of the standard shapes can be selected as a representative standard shape, and the representative standard shape is stored in the storage unit 33 (S14). The representative standard shape may be any one of the standard shapes. Preferably, the representative standard shape may be a standard shape of sample data that includes the target component at the highest concentration. Such a standard shape of sample data that includes the target component at the highest concentration can be selected after a known concentration of internal standard substance is added to each of the samples.

The comparison unit 14 compares the above-described plurality of standard shapes to the representative standard shape (S15). In step S15, the overlapping unit 14b of the comparison unit 14 overlaps each of the above-described standard shapes with the representative standard shape. At this time, the positions in the time axis direction of the standard shapes may be adjusted to match the position in the time axis direction of the representative standard shape, based on pre-acquired position information in the time axis direction of the target component.

The magnification obtaining unit 14c obtains the magnifications of the respective standard shapes, that is, the magnifications of intensities in the quantitative parameter axis direction, relative to the representative standard shape (S15). As described above, when samples including the same target component are analyzed by the same analysis system, magnifications are approximately the same at positions in the time axis direction. However, there may be error in the magnifications depending on the position. For this reason, the magnifications in the intensity axis direction (which may be simply referred to as the magnifications) of each of the standard shapes relative to the representative standard shape are obtained at a plurality of positions in the time axis direction (at intervals of 0.001 to 0.5 in the time axis direction, for example). The mode of each of the standard shapes can be used as a representative magnification value in the intensity axis direction (which may be simply referred to as a representative magnification value).

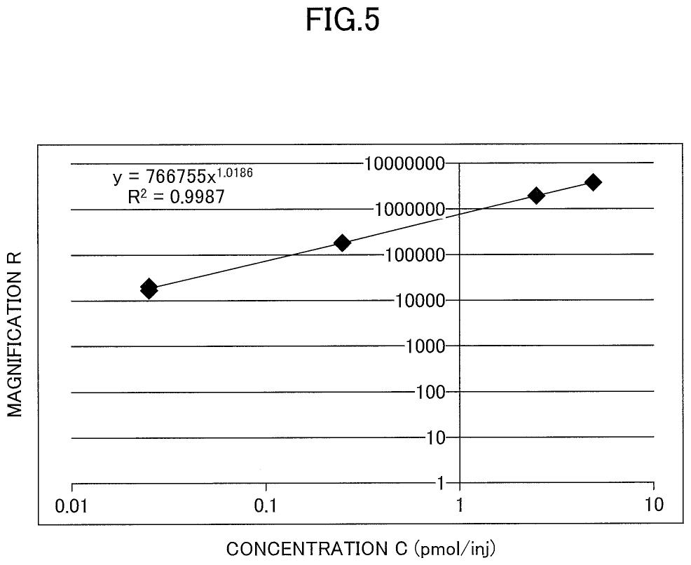

The regression equation generation unit 16 generates a regression equation that represents the relationship between the quantitative values (concentrations) of the target component and the representative magnification values of the standard shapes obtained in step S15 (S16). For example, the magnifications in the intensity axis direction of the peaks of different concentrations of D-asparagine in the chromatogram illustrated in FIG. 1 (a) are obtained, and the relationship between the concentrations of D-asparagine and the magnifications in the intensity axis direction is depicted in FIG. 5.

The relationship between the concentrations and the magnifications may be expressed by linear approximation. However, as illustrated in FIG. 5, the concentration C correlates well with the magnification R on a log-log graph. That is, the relationship between the concentration C and the magnification R can be approximated by an exponential regression equation:

log R=a log C+b(where a and b are coefficients)

The storage unit 33 stores the above-described regression equation together with the representative standard shape. At this time, the representative standard shape may be corrected. For example, the sizes in the quantitative parameter axis direction of the standard shapes may be changed at the representative magnification values of the standard shapes. Then, the representative standard shape may be corrected based on the standard shapes whose sizes were changed.

Accordingly, calibration data including the standard shapes and the regression equation can be generated by the calibration data generation process. Therefore, a component, whose quantitative value is unknown, can be analyzed and quantified based on the calibration data.

Note that the calibration data generation process is preferably performed each time the analytical conditions are changed. For example, if the analyzer 40 is a chromatograph, the calibration data generation process is preferably performed each time a column or a mobile phase is changed.

Further, the calibration data generation process is more preferably performed each time a measurement sample is analyzed.

### (Quantification Process)

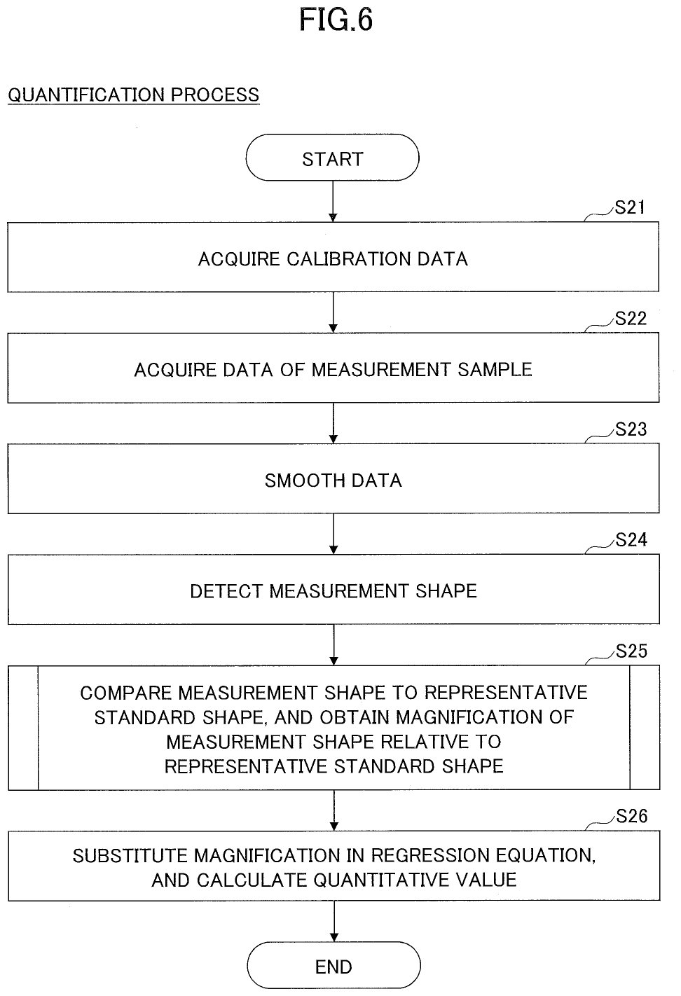

Next, a process for quantifying a sample including a component whose quantitative value is unknown will be described. FIG. 6 is a flowchart of a quantitation process according to the present embodiment.

The data acquisition unit 11 acquires calibration data (including standard shapes and a regression equation) acquired in advance by the above-described calibration data generation process (S21). If calibration data is stored in the storage unit 33, the data acquisition unit 11 can read the calibration data from the storage unit 33.

The data acquisition unit 11 acquires data of a measurement sample including a target component whose quantitative value is unknown, from the analyzer 40 (S22). The format of this data is the same as the format of the calibration data. That is, if the calibration data is data represented by time, which is a non-quantitative parameter, and signal intensity, which is a quantitative parameter (such as a chart represented by a time axis and an intensity axis), the data acquired in step S22 is also data represented by time and signal intensity. Further, the data of the measurement sample is acquired under the same analytical conditions as the calibration data acquired by the calibration data generation process.

The smoothing unit 12 performs a smoothing process on the data of the measurement sample (S23). The smoothing process performed in S23 is similar to the smoothing process (S12) performed in the calibration data generation process.

The target component data detecting unit 13 detects data of the target component from the smoothed data of the measurement sample, and extracts the data shape (measurement shape) of the target component (S24). At this time, pre-acquired position information (position information in the time axis direction) of the target component can be used. The storage unit 33 stores the measurement shape.

Next, the comparison unit 14 compares the measurement shape to a representative standard shape preliminarily acquired by the calibration data generation process (S25). As a result of the comparison, the comparison unit 14 obtains the magnification (of the intensity in the quantitative parameter axis direction) of the measurement shape relative to the representative standard shape (S25). If the measurement sample includes a trace amount of the target component, the accuracy of comparison may be decreased due to error caused by mechanical or electrical noise of the apparatus. In order to improve the accuracy of comparison, a part of the measurement shape suitable for comparison can be extracted, and the part of the measurement shape can be compared to the standard shape, as will be described later. In addition, an internal standard may be added to the standard shapes beforehand such that a decrease in accuracy of the S/N ratio of the measurement shape of a trace amount of the target component can be prevented.

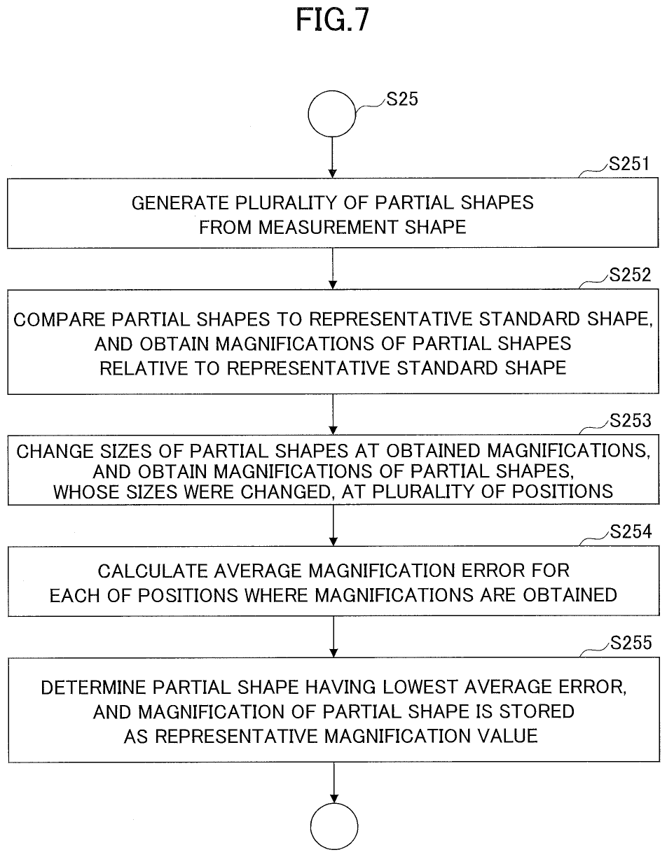

FIG. 7 is a flowchart illustrating details of a comparison procedure (S25).

The partial shape generating unit 14a divides the measurement shape in the time axis direction into a plurality of divided portions (S251). Then, the partial shape generating unit 14a acquires a partial shape that includes one or more consecutive divided portions. At this time, a plurality of partial shapes are preferably acquired, such that each of the partial shapes consecutively includes the highest point of the measurement shape (the position where the magnitude or the absolute value of the quantitative parameter of the measurement shape is highest) and one or more divided portions. In addition, partial shapes of all combinations of the divided portions are preferably acquired.

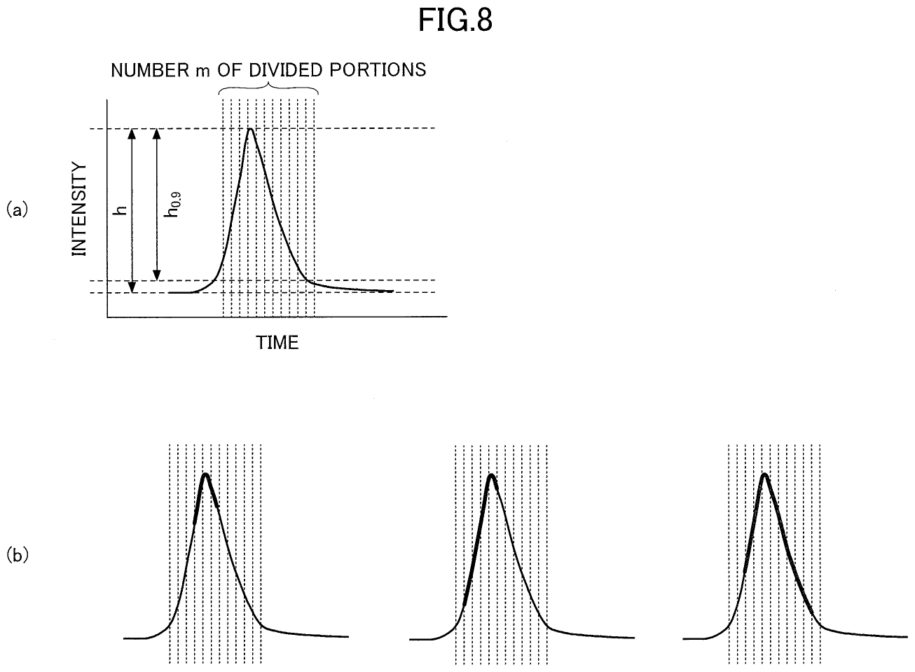

FIG. 8 is a schematic diagram illustrating a partial shape generation procedure (S251). When the partial shape generating unit 14a divides the measurement shape, the measurement shape can be divided within a range h_{0.9} of 90% of the height h of the measurement shape (FIG. 8(a)). The number m of divided portions may depend on the size of the shape and is not particularly limited, but the width in the time axis direction of the shape is preferably divided into 5 or more portions.

Further, in order to set a divided range in which the highest point of the measurement shape is located in the middle, it is preferable to set the number m to an odd number such that the highest point of the measurement shape is included in the middle of divided portions. After the divided portions are formed, a shape (partial shape) that includes the highest point (peak top) of the measurement shape and one or more consecutive divided portions is acquired. Example partial shapes are indicated by thick lines in FIG. 8(b). In this manner, a plurality of partial shapes are generated, and a partial shape suitable for comparison is selected from the plurality of partial shapes.

The comparison unit 14 compares each of the partial shapes to the representative standard shape (S252). The overlapping unit 14b of the comparison unit 14 overlaps each of the partial shapes with the representative standard shape. At this time, the overlapping unit 14b causes the position (the position of the highest point) in the time axis direction of each of the partial shapes to match the position of the representative standard shape, based on pre-acquired position information in the time axis direction of the target component.

If quality control as will be described later is performed in the analysis method according to the present embodiment, the comparison unit 14 can compare a data shape obtained from data of a quality control sample to the representative measurement shape.

The magnification obtaining unit 14c obtains the magnifications in the intensity axis direction of each of the partial shapes relative to the representative standard shape, at a plurality of positions (points) in the time axis direction (S252). At this time, the magnifications of each of the partial shapes may be obtained at intervals of 0.01 to 0.5 in the time axis direction. Further, the mode of the magnifications is set to be the “magnification in the intensity axis direction” of each of the partial shapes.

Then, the size of each of the partial shapes is changed (enlarged or reduced) at the “magnification in the intensity axis direction” of 5⁻ each of the partial shapes (S253). At this time, the overlapping unit 14b overlaps each of the partial shapes, whose sizes were changed, with the representative standard shape. Then, the magnification obtaining unit 14c obtains the magnifications of each of the partial shapes at the plurality of positions in the time axis direction. For each of the partial shapes, the magnification obtaining unit 14c calculates errors between the obtained magnifications and the “magnification in the intensity axis direction”. Then, for each of the partial shapes, the magnification obtaining unit 14c calculates the average error for each of the points (for each of the positions where the magnifications are obtained) (S254).

In order to further increase the accuracy, when the overlapping unit 14b overlaps each of the partial shapes with the representative standard shape, the position of the highest point of each of the partial shapes and the position of the highest point of the representative standard shape may be shifted in the time axis direction, and the magnifications of each of the partial shape may be obtained at positions shifted in the time axis direction. The average error can be calculated based on errors calculated in the above-described case.

From among the plurality of partial shapes, a partial shape having the lowest average error is determined as a partial shape suitable for comparison, and the magnification in the intensity axis direction of this partial shape is stored as a representative magnification value of the measurement shape (S255).

Referring back to FIG. 6, the quantitative value calculation unit 15 can substitute the representative magnification value of the measurement shape into the regression equation, obtained in advance by the calibration data generation process, and calculate the quantitative value of the target component in the measurement sample (S26).

The two-dimensional data represented by the two parameters, time and signal intensity, has been mainly described above. However, data represented by the n number of parameters, that is, n-dimensional data may be analyzed according to an embodiment of the present invention.

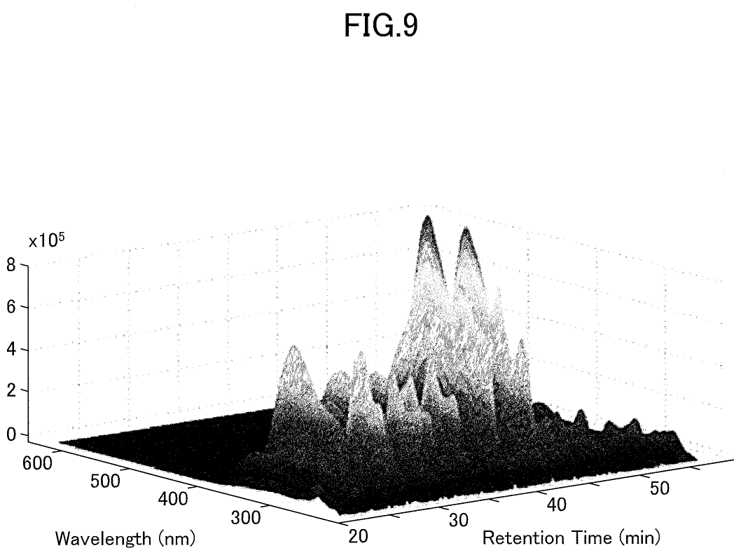

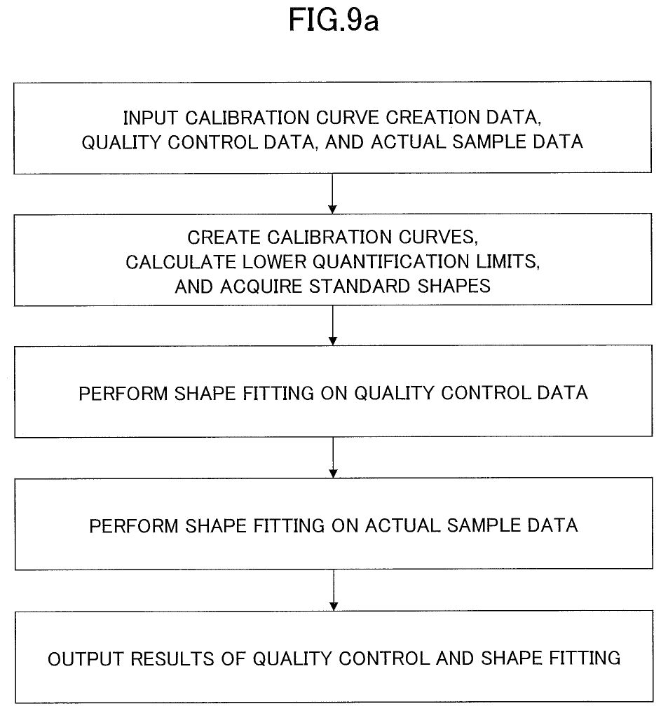

As an example, three-dimensional data is depicted in FIG. 9. The data in FIG. 9 indicates a commercially available Ginkgo biloba product obtained by the HPLC-SPE-NMR technique. The data illustrated in FIG. 9 includes information (a parameter) obtained from ¹H-NMR (nuclear magnetic resonance) in addition to the retention time (parameter) obtained by high-performance liquid chromatography (HPLC) and the signal intensity (parameter) obtained from a detector. The characteristics of a component in the sample are represented by the three parameters.

Further, in the analysis method according to the present embodiment, quality control (QC) for analytical conditions can be performed. That is, a quality control step of performing quality control for analytical conditions may be included in the analysis method according to the present embodiment. The analytical conditions include the accuracy of calibration curves, blank noise/carryover, quantification accuracy, and separation accuracy. For quality control, quality control data prepared beforehand can be used. The quality control data includes data of a validation sample prepared from a standard sample.

In one analysis method, in addition to calibration curve creation (calibration) data (standard data) and measurement sample data (actual sample data), quality control data can be input, and based on the input data, the creation of calibration curves, quality control, and identification and quantification of a target component in a measurement sample can be performed.

For example, FIG. 9a is a flowchart of a an analysis method including a quality control step. The process indicated in FIG. 9a can be performed by using dedicated software. As illustrated in FIG. 9a, in this method, calibration curve creation data, quality control data, and measurement sample data (actual sample data) are input. Based on the input data, calibration curves are created and the lower quantification limits can be calculated. Further, standard shapes can be acquired from the calibration curve creation data. Standard shapes or a representative standard shape can be acquired by the method described in the above calibration data generation process.

Then, the standard shapes obtained from the calibration curve creation data are compared to the data shape of the quality control data. That is, shape fitting can be performed based on the quality control data. In addition, the standard shapes are compared to the data shape of the actual sample data. That is, shape fitting can be performed based on the actual sample data.

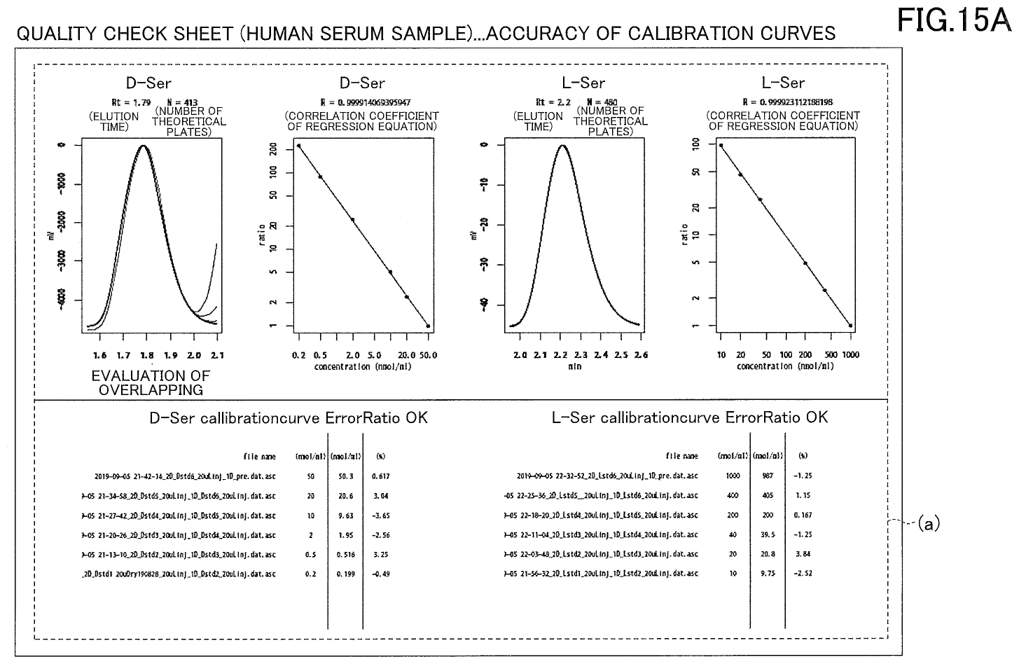

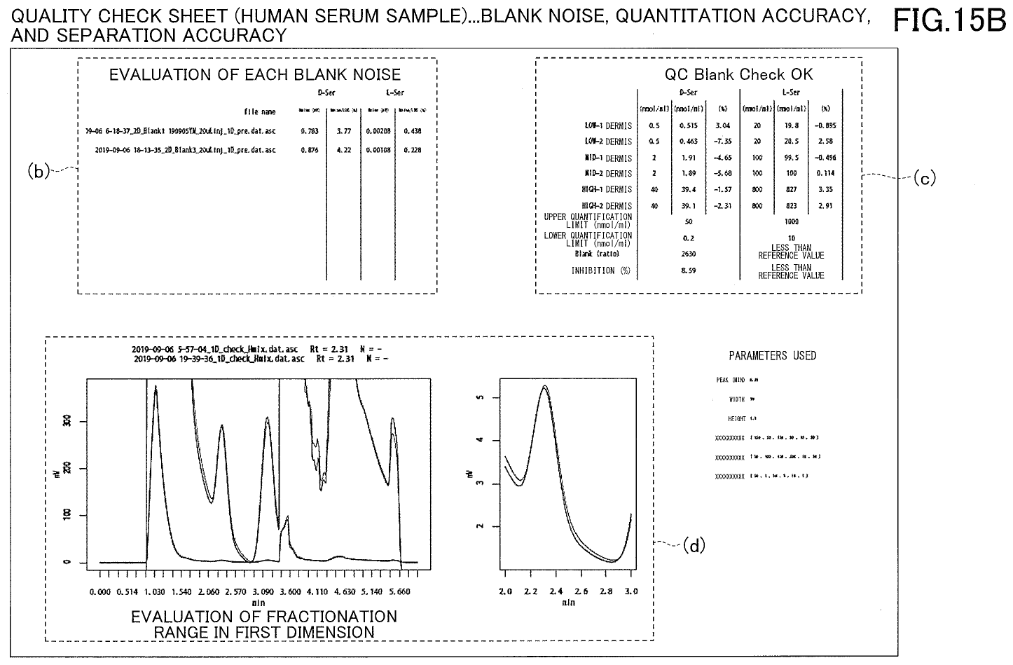

An automatic analysis/report function of software can be used to output the results of the quality control and shape fitting as quality check sheets. The quality check sheets can display the results of the accuracy of calibration curves, blank noise/carryover, separation accuracy, quantification accuracy, and the like (which will be described later with reference to FIG. 15A and FIG. 15B).

Accordingly, in the analysis method according to the present embodiment, the accuracy/quality evaluation of the analysis system and the analysis of quantification can be performed at the same time, thus enabling a more accurate analysis.

### EXAMPLES

### Example 1

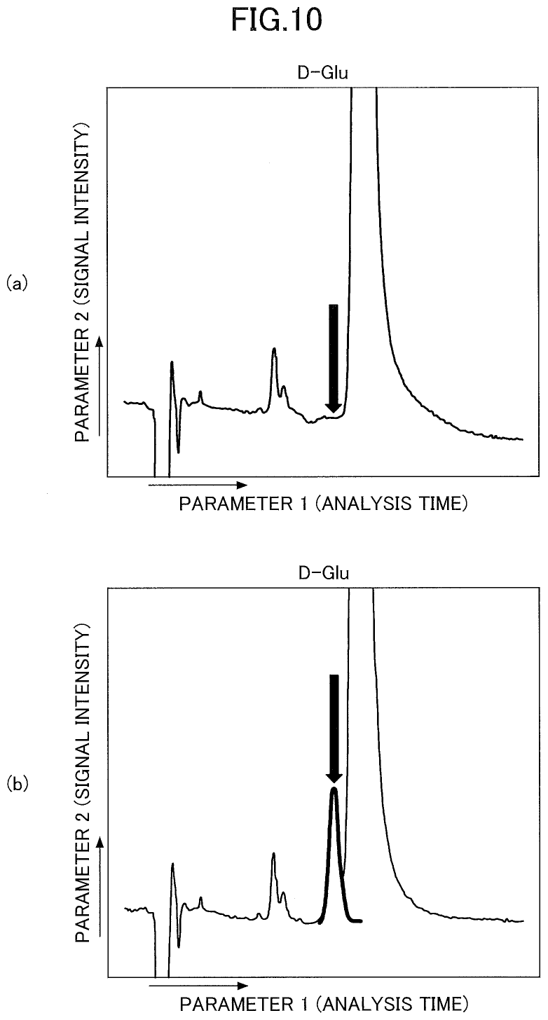

A standard plasma sample A from a human was used for separation analysis by a high-performance liquid chromatography-fluorescence detection method. An obtained chromatogram confirmed that the sample A did not include D-glutamic acid (indicated by an arrow in FIG. 10(a)). The position in the time axis direction (retention time) at which the peak of D-glutamic acid appears under the same analytical conditions was confirmed in advance.

Next, 19.75 fmol/inj of D-glutamic acid was added to the sample A, and the sample A was separated and analyzed under the same analytical conditions to obtain a chromatogram (data) (FIG. 10(b)). Based on the peak of D-glutamic acid in the obtained chromatogram, D-glutamic acid was quantified by the analytical method described above with reference to FIGS. 4, 6, and 7.

In this example, when the magnifications of standard shapes (standard peaks) relative to a representative standard shape (representative standard peak) were obtained as described in step S15 of the calibration data generation process, the magnifications were obtained every 0.2 seconds in the time axis direction, and the mode of the magnifications was obtained as a representative magnification value.

Further, when partial shapes were generated as described in the partial shape (partial peak) generation procedure (S251) of the quantification process, a measurement shape was divided into 21 portions within the above-described height range, and shapes of all combinations that consecutively include the peak top and one or more of the 21 divided portions were acquired as partial shapes (partial peaks). Further, when the magnifications of the partial shapes (partial peaks) relative to the representative standard shape (representative standard peak) were obtained, the magnifications were obtained at every 0.2 seconds in the time axis direction, and the mode of the magnifications was calculated.

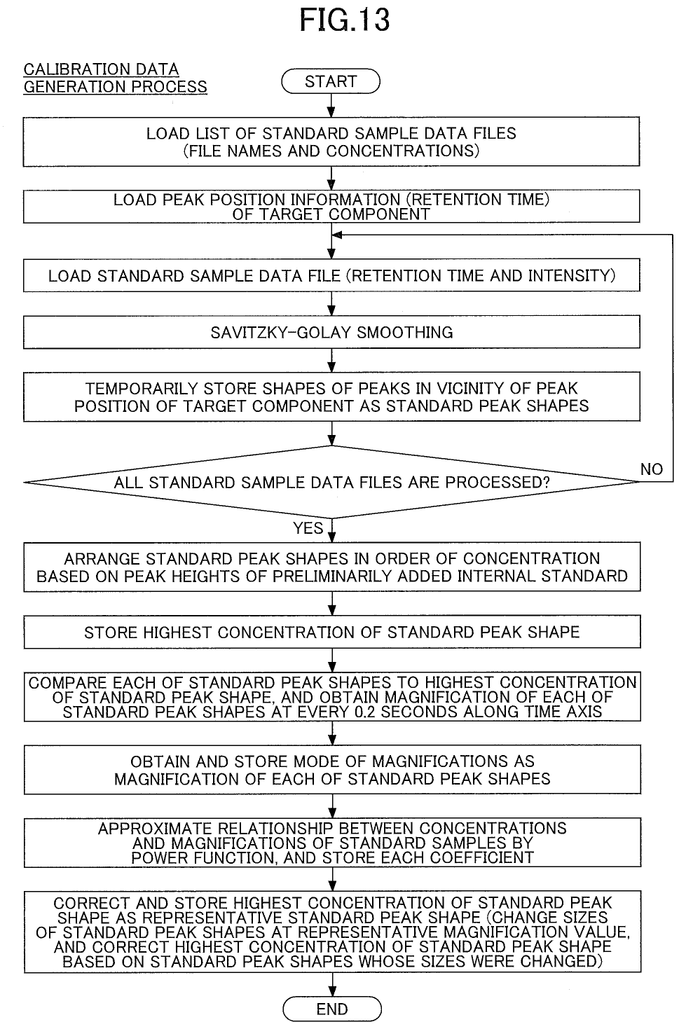

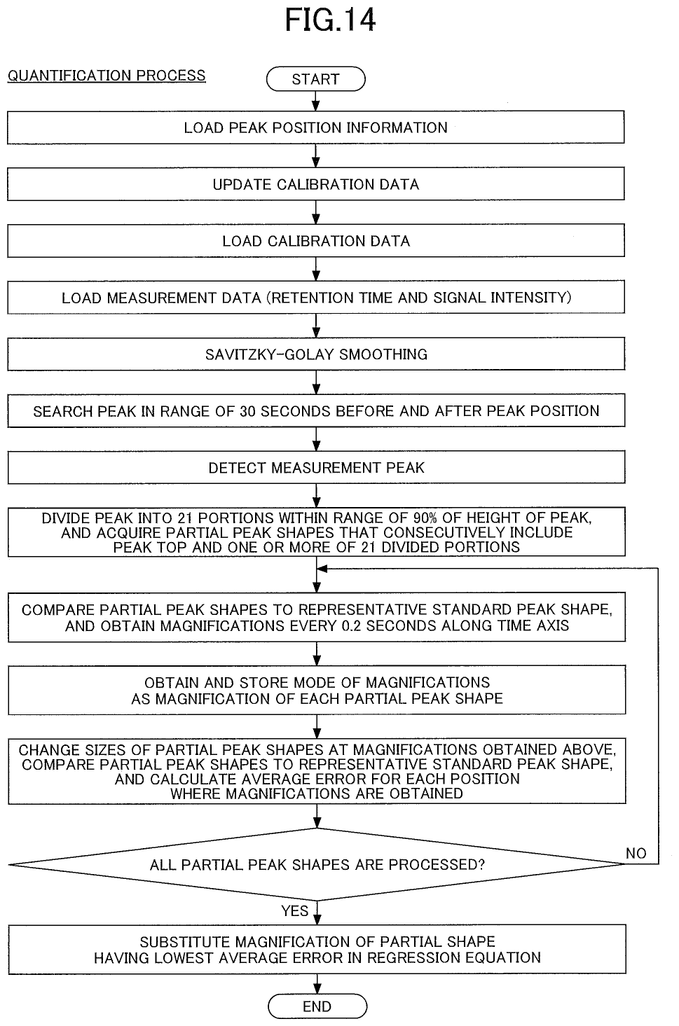

FIG. 13 and FIG. 14 are flowcharts illustrating details of a calibration data generation process and a quantification process in this example.

The concentration of D-glutamic acid calculated by the above-described analysis method was 18.86 fmol/inj. Then, 18.86 fmol/inj was compared to 19.75 fmol/inj, which was actually added to the sample A. The error (18.86/19.75×100) was approximately 4.5%.

### Example 2

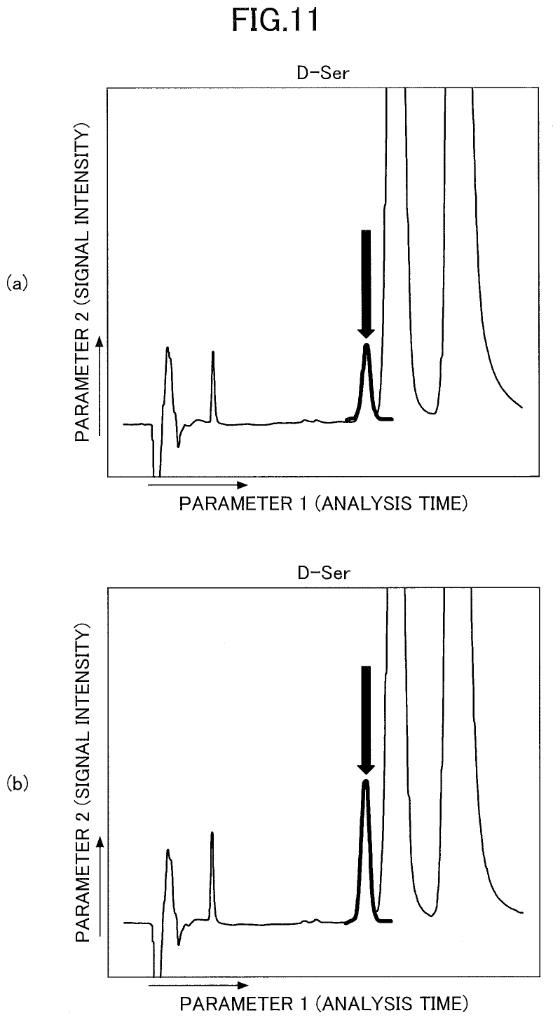

Similar to Example 1, a standard plasma sample B from a human was used for separation analysis by high-performance liquid chromatography. Based on a chromatogram (FIG. 11(a)) obtained, a target component, D-serine, was quantified by the same analysis method as Example 1. As a result, the concentration of D-serine was 14.93 fmol/inj.

Next, 16.46 fmol/inj of D-serine was added to the sample B, and the sample B was separated and analyzed under the same analytical conditions to obtain a chromatogram (FIG. 11(b)). Based on the obtained chromatogram, D-serine was quantified by the same analytical method as in Example 1. As a result, the concentration of D-serine was 30.33 fmol/inj.

The difference in the concentration of D-serine before and after the addition of D-serine was 30.33−14.93=13.87 fmol/inj, which was calculated by the analysis method according to the embodiment of the present invention. As compared to the concentration of D-serine before 16.46 fmol/inj was added, it can be said that the error (13.87/14.93×100) was approximately 7%.

### Example 3

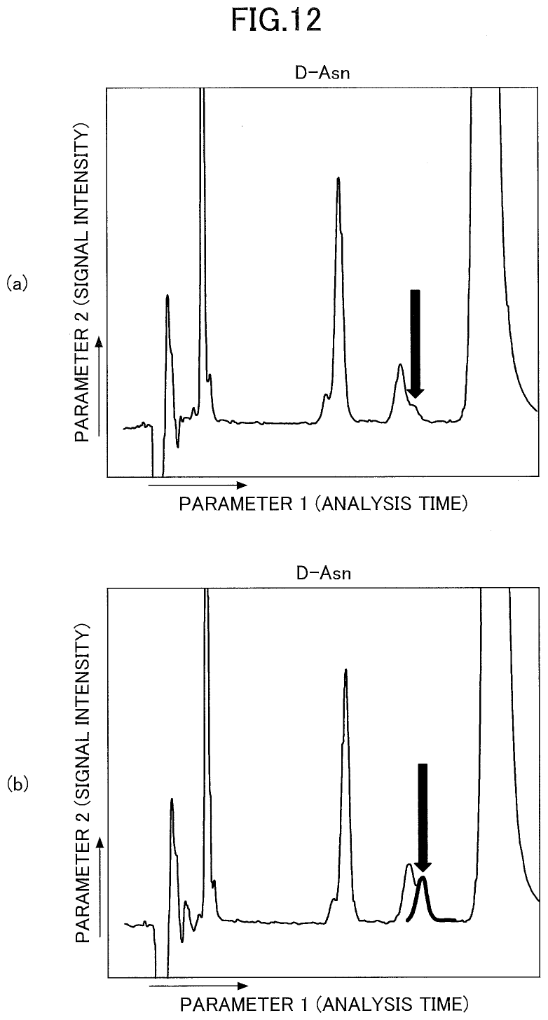

Similar to Example 1, a standard plasma sample C from a human was used for separation analysis by high-performance liquid chromatography, and a chromatogram was obtained. The position (retention time) in the time axis direction of a target component, D-asparagine, was acquired beforehand under the same analytical conditions, and the peak of D-asparagine was slightly confirmed and seemed to be present based on the position in the time axis direction of the target component. However, it was difficult to quantify the target component (FIG. 12(a)).

Next, 4.12 fmol/inj of D-asparagine was added to the sample C, and the sample C was separated and analyzed under the same analytical conditions to obtain a chromatogram (FIG. 12(b)). Based on the obtained chromatogram, D-asparagine was quantified by the same analytical method as in Example 1. As a result, the concentration of D-asparagine was 4.22 fmol/inj. Accordingly, the content of D-asparagine in the sample C can be estimated to be 4.22-4.12=0.1 fmol/inj.

As described above, there is no established method or standard for drawing a baseline for the peak of the target component, and the baseline can be drawn in any way. Therefore, there may be limitations in separating the target component from surrounding contaminants, and the error may sometimes exceed 100%. Conversely, in the analysis method according to the embodiment of the present invention, the shapes of peaks are used for separation of the target component. Accordingly, the target component having a peak that overlaps the peak of another component can be quantified with an error of 20% or less or approximately 10% or less.

Further, according to the embodiment of the present invention, a trace amount of a component, which is difficult to be analyzed in data obtained by a typical separation analysis method, can be analyzed. Accordingly, in the embodiment of the present invention, 1 fmol/inj or less and preferably 100 amol/inj or less of a component can be quantified. For example, the embodiment of the present invention can be suitably used to analyze components, contained in trace amounts in a sample, such as in vivo D-amino acids, peptides, drug metabolites, and the like.

### Example 4

In Example 4, the quantitative analysis and quality evaluation of an analysis system were performed. In this example, sample data for standard shape/calibration curve creation, quality control (QC) samples, a human blood sample (serum actual sample), and a human urine sample (actual sample) were used for separation and analysis of D-serine and L-serine by a two-dimensional high-performance liquid chromatography-fluorescence detection method.

After D-serine and L-serine were separated and analyzed, calibration curves of the human blood sample and the human urine sample were created based on the sample data for standard shape/calibration curve creation, and lower quantification limits were calculated. In addition, standard shapes were obtained. The obtained standard shapes and calibration curves were applied to chromatograms of the human blood sample and the human urine sample. In this manner, the quality of the analysis conditions (the accuracy of calibration curves, blank noise/carryover, quantitation accuracy, and first dimension separation accuracy) was checked, and the quantitative values of D-serine and L-serine, which were target components, were calculated.

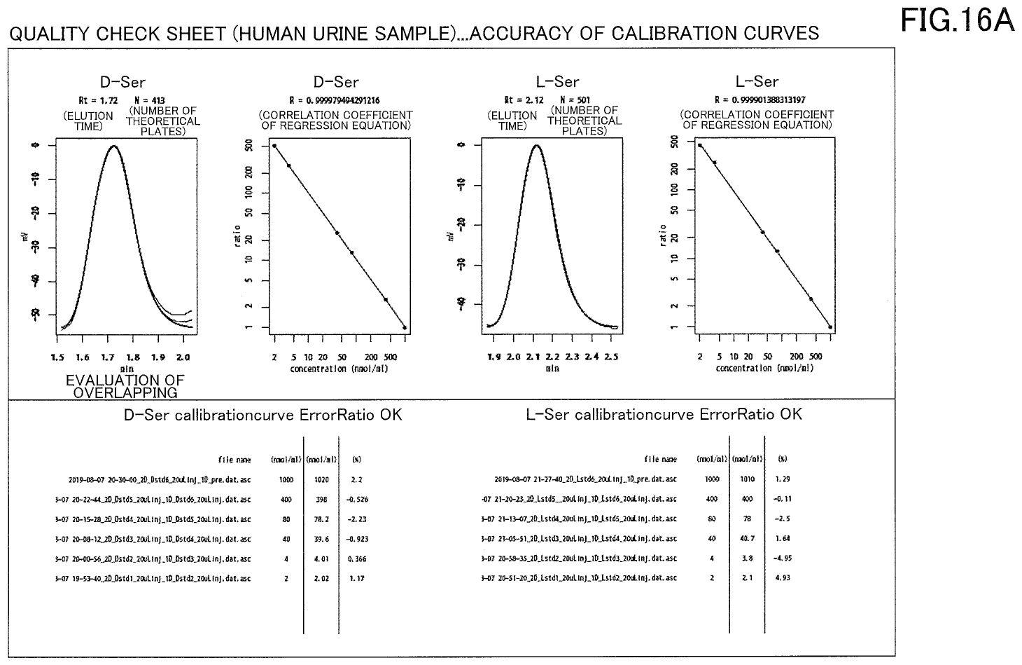

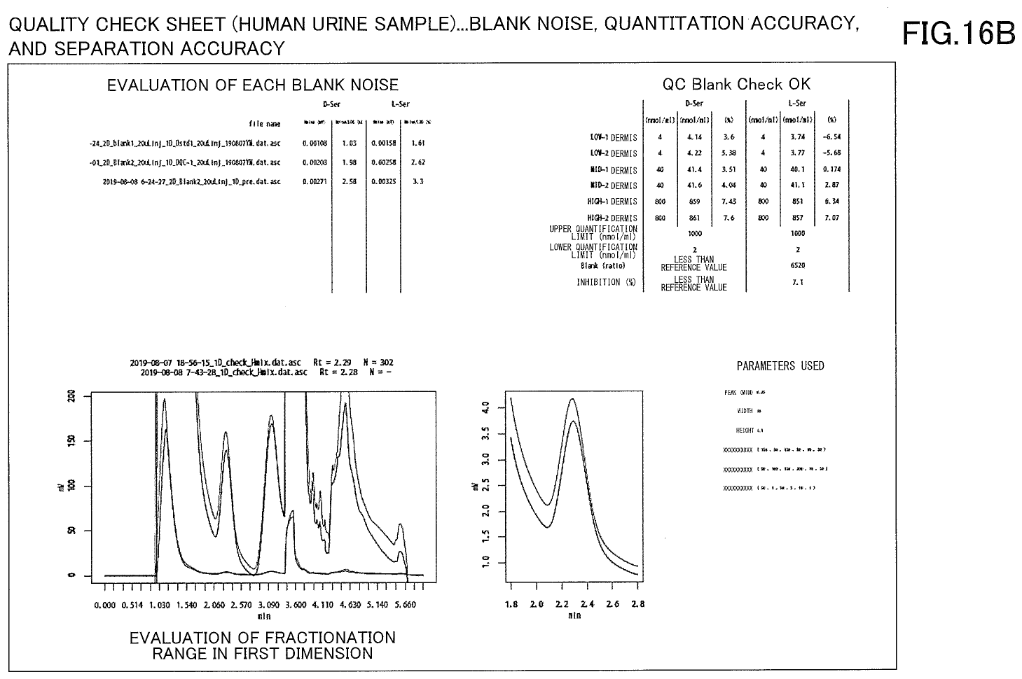

The automatic analysis/report function of the dedicated software is used to output quality check sheets. FIG. 15A and FIG. 15B illustrate quality check sheets for the blood sample. FIG. 16A and FIG. 16B illustrate quality check sheets for the urine sample. As illustrated in the quality check sheets of FIG. 15A and FIG. 15B, (a) the accuracy of calibration curves, (b) blank noise/carryover, (c) quantification accuracy, and (d) separation accuracy were evaluated.

The separation conditions in each dimension of the two-dimensional high-performance liquid chromatography were as follows.

### <First Dimension>

Column: KSAARP (3 μm), 1.0 mm (inner diameter)×50 mm, 40° C.
Mobile phase: 2% MeCN and 0.1% formic acid in H₂O, 400 μL/min

### <Second Dimension>

Column: KSAACSP-001S (5 μm), 1.5 mm (inner diameter)×75 mm, 40° C.
Mobile phase: 0.075% formic acid in MeOH/MeCN (90/10, v/v), 1000 μL/min

In the blood sample, the calibration error range of the analytical conditions of D-serine was within 3.65% and the calibration error range of the analytical conditions of L-serine was within 3.84%, the lower quantification limit of D-serine was 0.2 nmol/mL and the lower quantification limit of L-serine was 10 nmol/mL, the blank noise of D-serine was within 4.22% and the blank noise of L-serine was within 0.438%, and the error of D-serine with respect to a known concentration of a QC sample was within 7.35% and the error of L-serine with respect to the known concentration of the QC sample was within 3.35%.

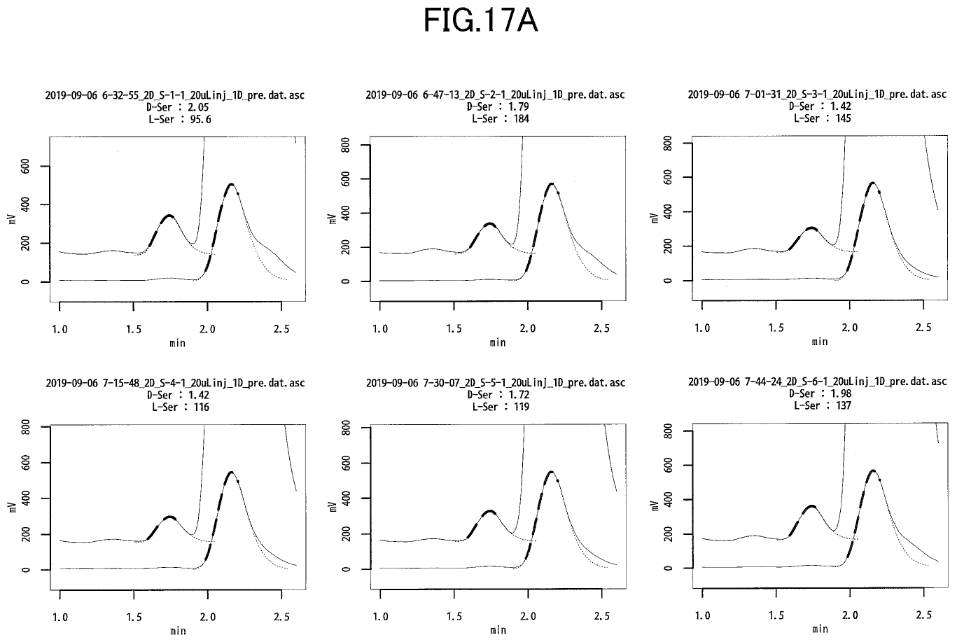

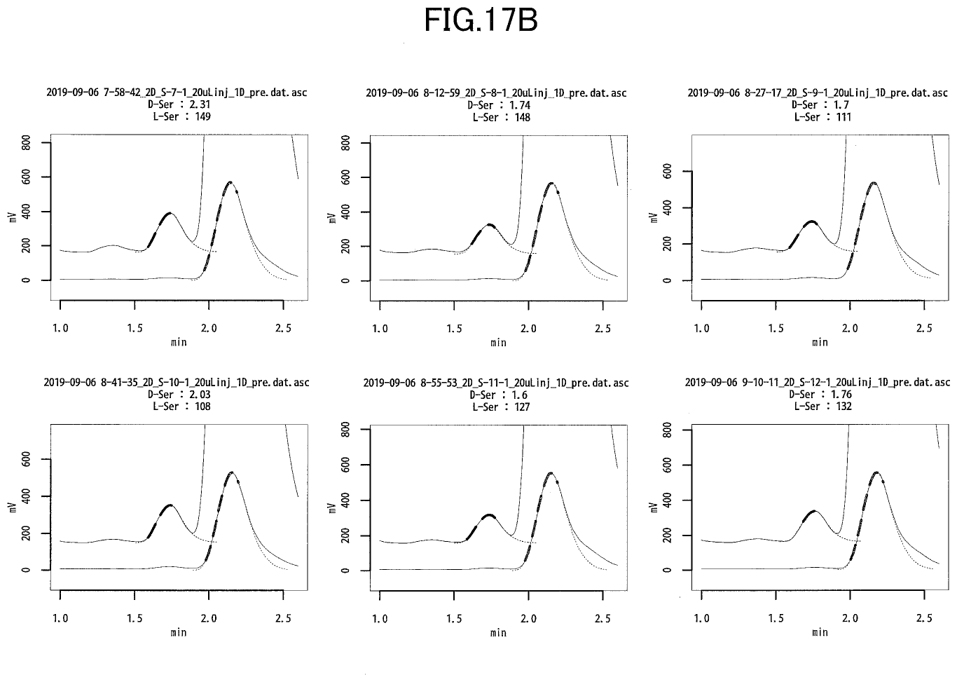

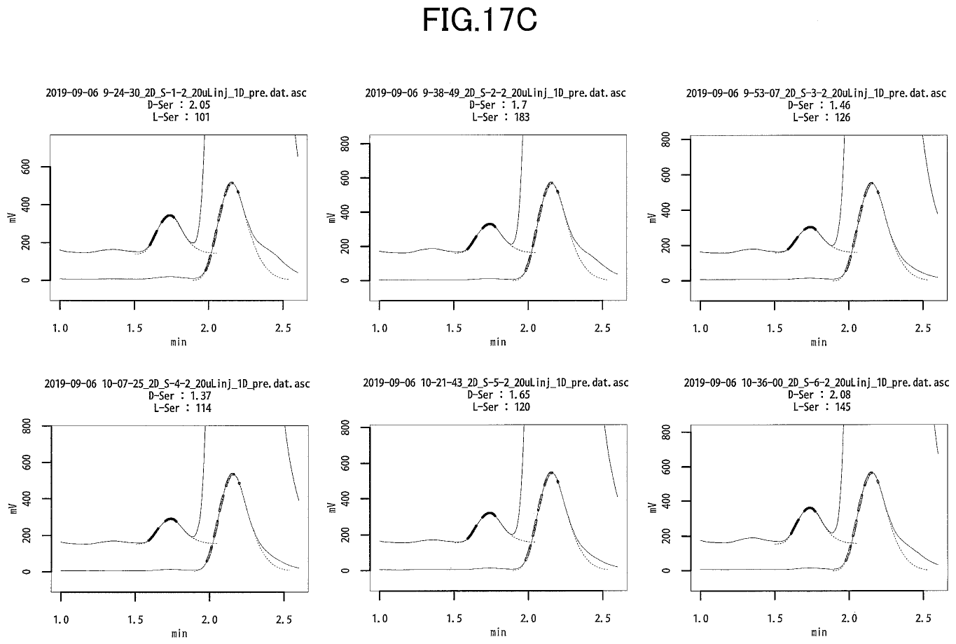

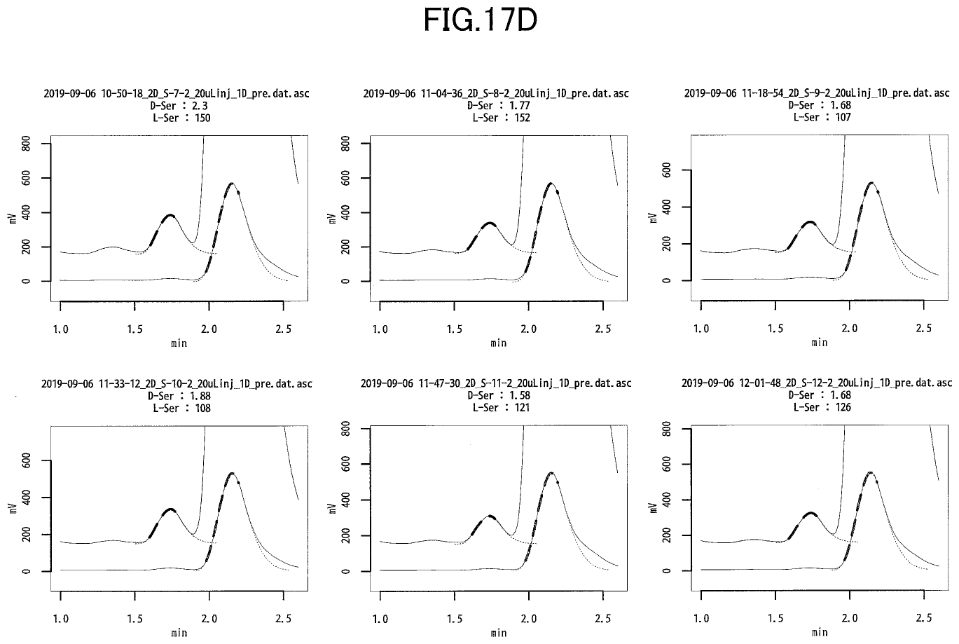

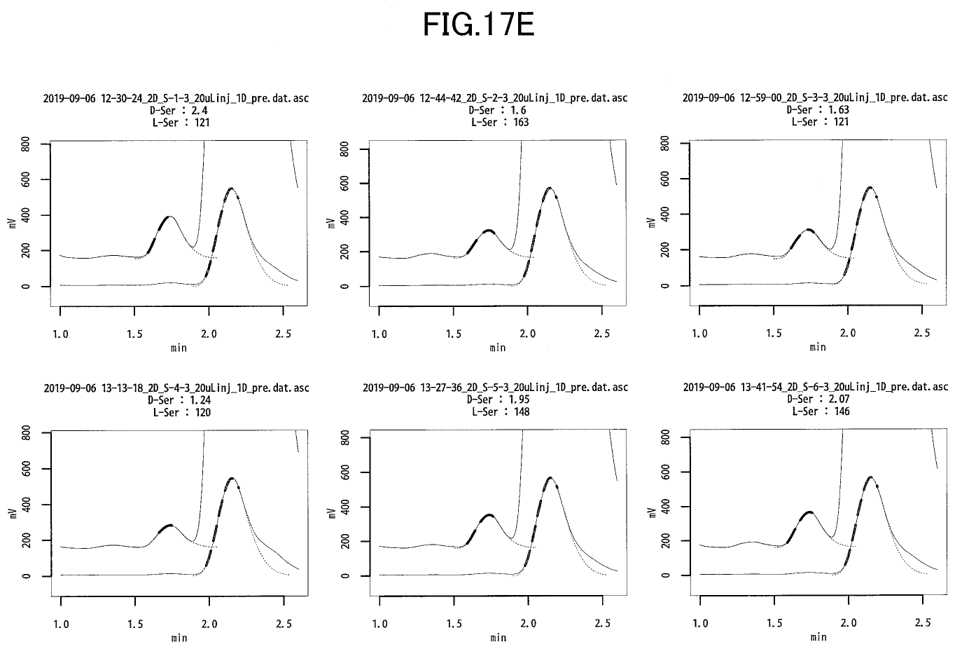

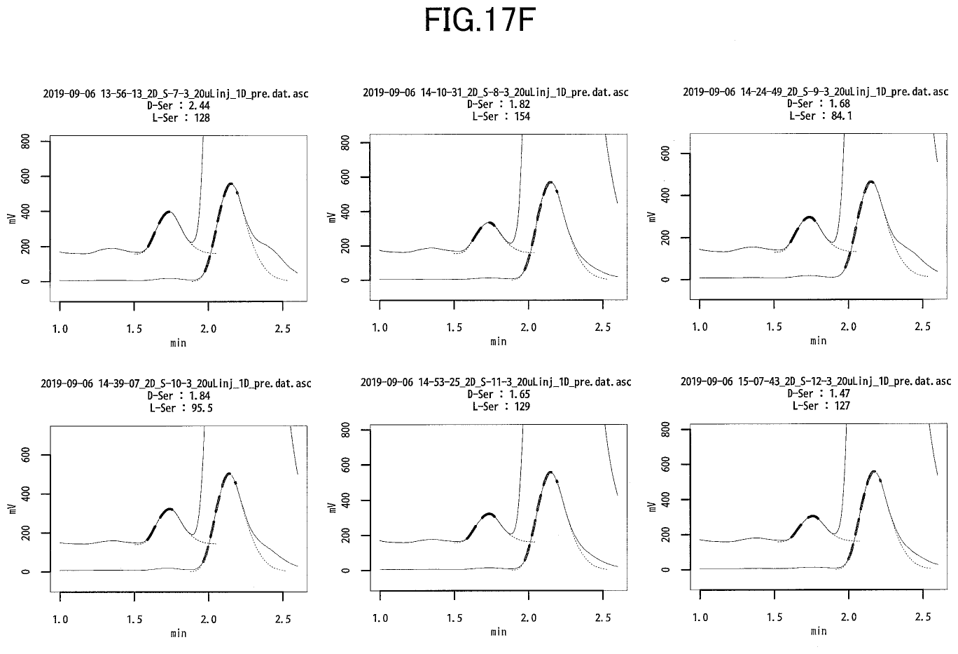

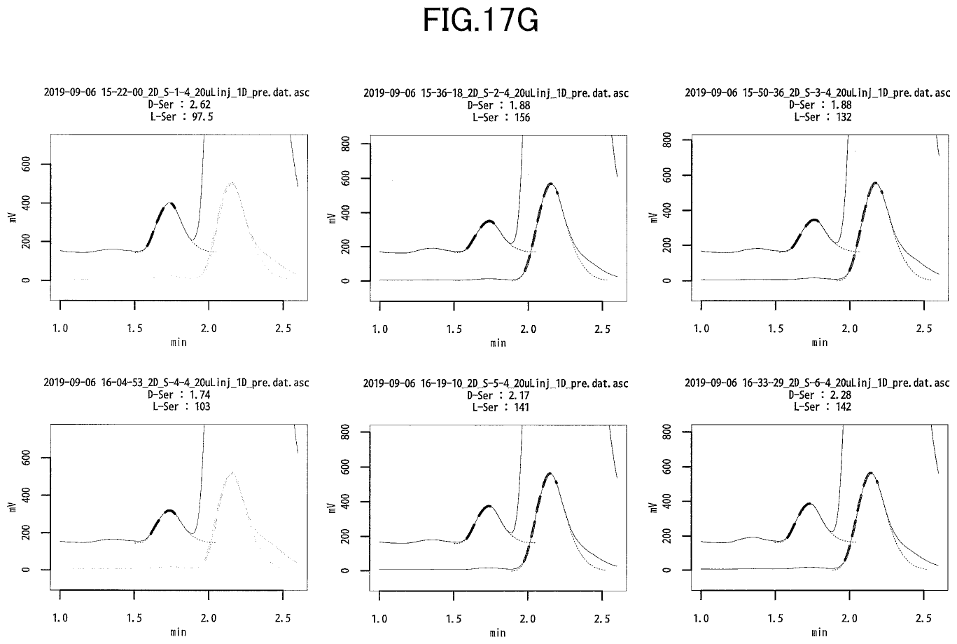

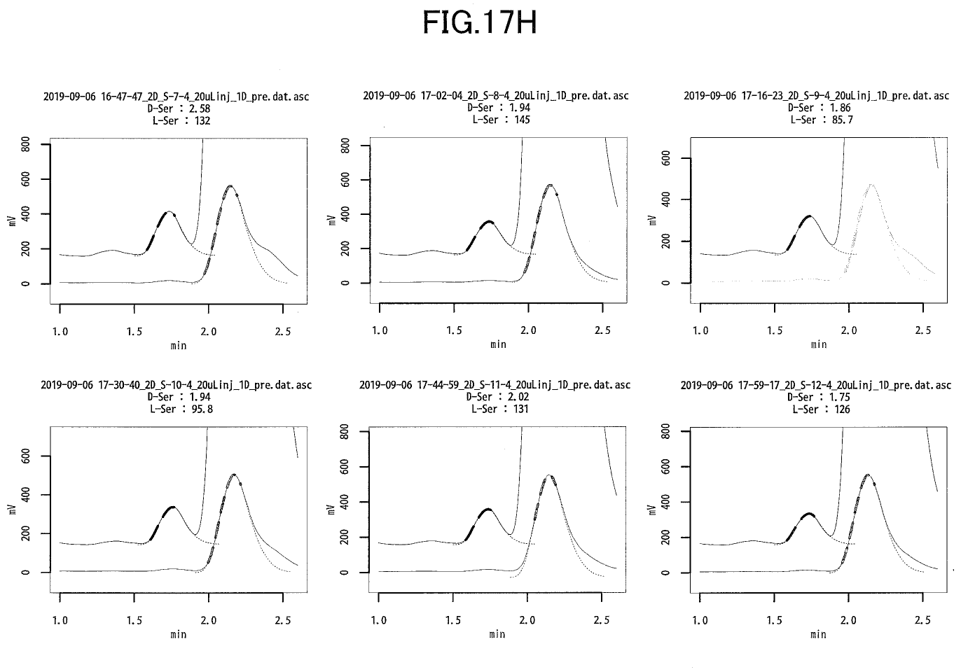

Further, a quantitative analysis was performed on 48 blood samples. FIGS. 17A through 17H depict the results. As illustrated in FIGS. 17A through 17H, the standard shapes (dashed lines) were caused to overlap with each other in the chromatograms (fits: thick dashed lines), and the quantitative values of D-serine and L-serine were calculated. The quantitative values (nmol/mL) were indicated at the upper portions of the chromatograms.

In the urine sample, the calibration error range of the analytical conditions of D-serine was within 2.23% and the calibration error range of the analytical conditions of L-serine was within 4.95%, the lower quantification limit of D-serine was 2 nmol/mL and the lower quantification limit of L-serine was 2 nmol/mL, the blank noise of D-serine was within 2.58% and the blank noise of L-serine was within 3.3%, and the error of D-serine with respect to a known concentration of a QC sample was within 7.6% and the error of L-serine with respect to the known concentration of the QC sample was within 7.07%.

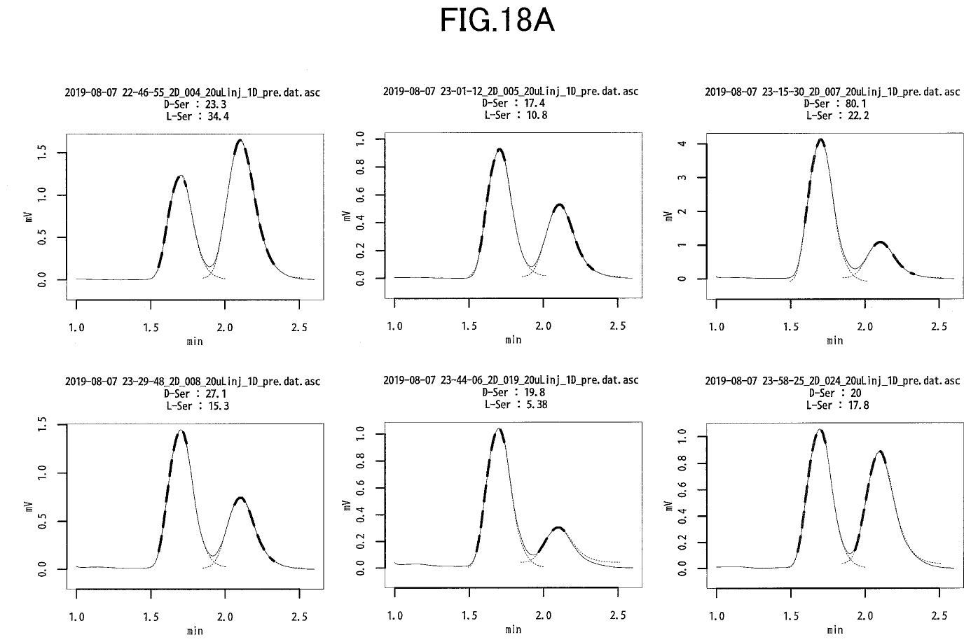

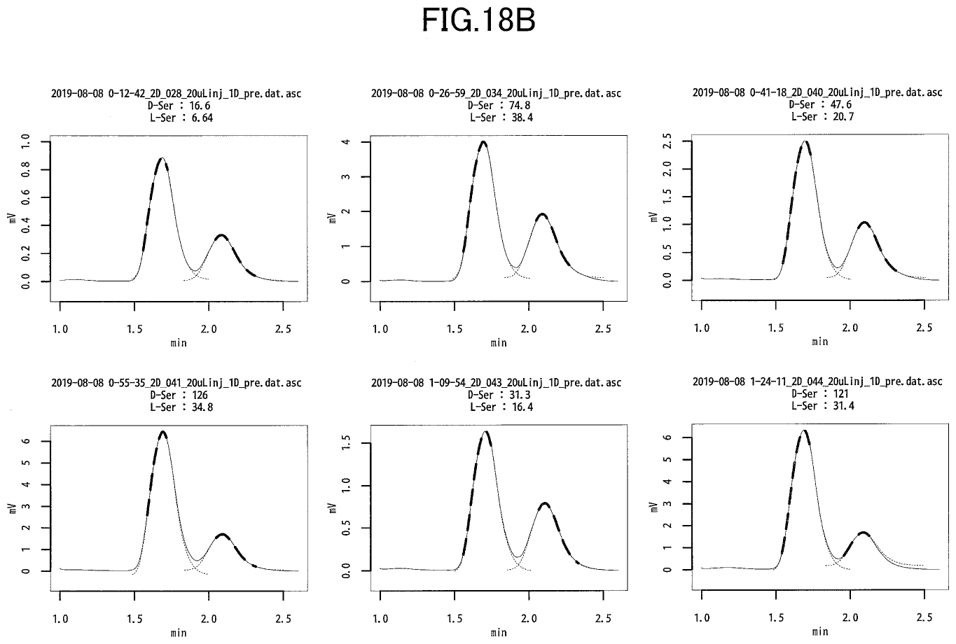

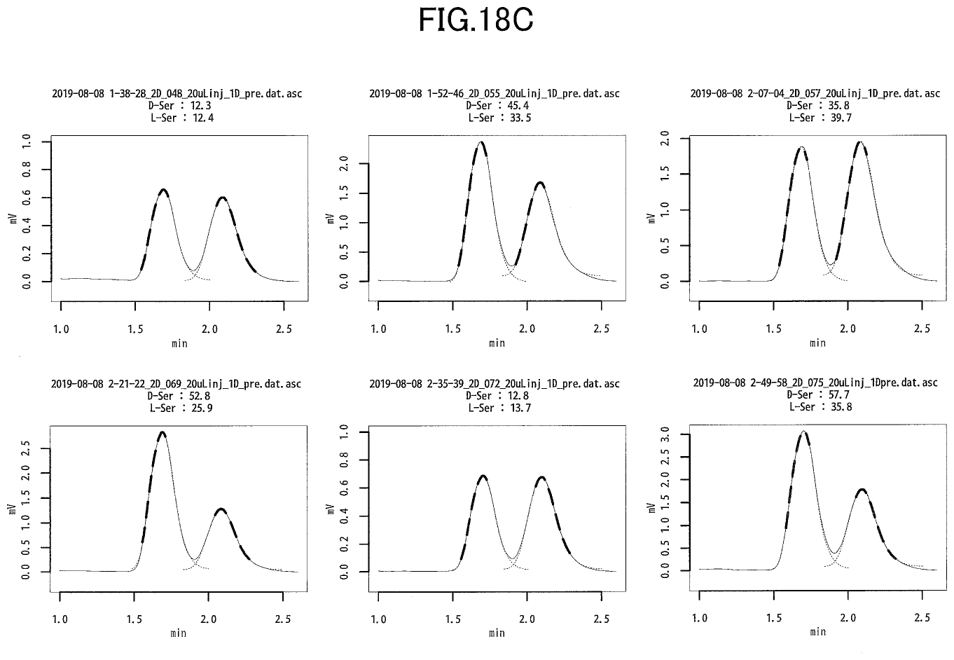

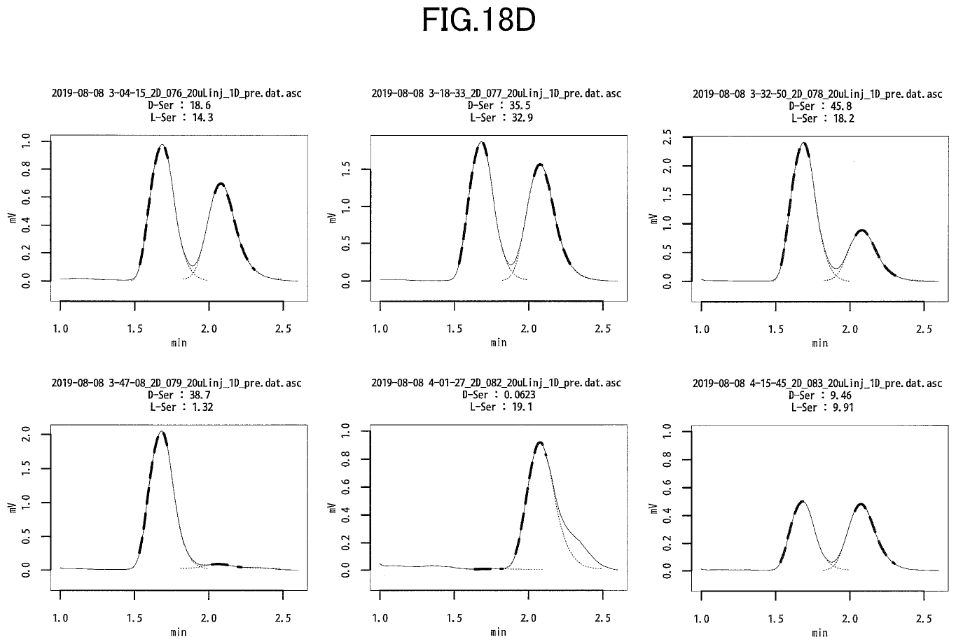

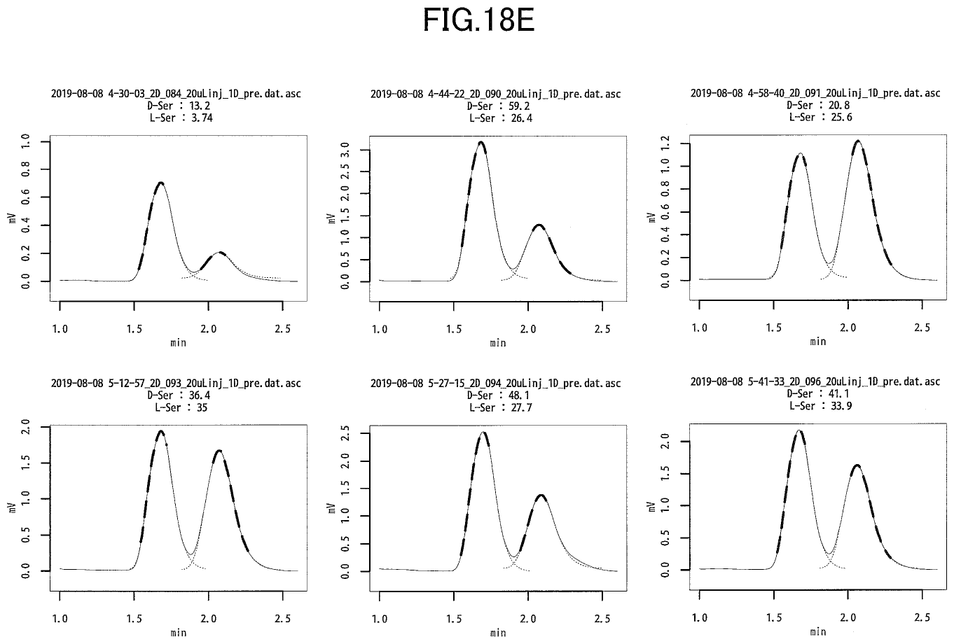

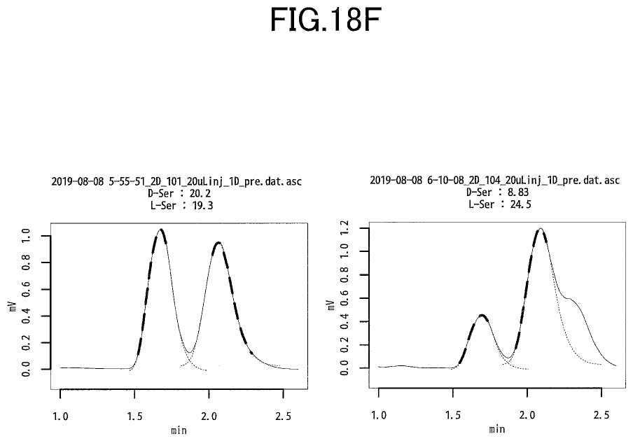

Further, a quantitative analysis was performed on 32 urine samples. FIGS. 18A through 18F depict the results. As illustrated in FIGS. 18A through 18F, the standard shapes (dashed lines) were caused to overlap with each other in the chromatograms (fits: thick dashed line), and the quantitative values of D-serine and L-serine were calculated. The quantitative values (nmol/mL) were indicated at the upper portions of the chromatograms.

Accordingly, the accuracy and quality evaluation of the analysis system can be performed simultaneously with a quantitative analysis, at a higher throughput than a conventional method, by utilizing the shape fitting method.

The present application is based on and claims priority to Japanese Patent Application No. 2018-192980 filed on Oct. 11, 2018, with the Japanese Patent Office, the entire contents of which are hereby incorporated by reference.

### DESCRIPTION OF REFERENCE NUMERALS

10 analysis apparatus
11 data acquisition unit
12 smoothing unit
13 target component data detecting unit
14 comparison unit
14a partial shape generating unit
14b overlapping unit
14c magnification obtaining unit
15 quantitative value calculation unit
16 regression equation generation unit
17 control unit
21 input device
22 output device
23 drive device
24 auxiliary storage device
25 memory device
26 CPU
27 network connection device
28 recording medium
31 input unit
32 output unit
33 storage unit
40 analyzer

1. An analysis method for data generated by at least two parameters, the method comprising:
making a comparison between a data shape of a target component in a measurement sample and a standard shape acquired in advance; and
identifying the target component in the measurement sample based on the comparison.

2. An analysis method for data generated by at least two parameters, the method comprising:
making a comparison between a data shape of a target component in a measurement sample and a standard shape acquired in advance; and
calculating a quantitative value of the target component in the measurement sample based on the comparison,
wherein the standard shape includes a group of shapes of the target component acquired from a plurality of standard samples containing the target component at different quantitative values.

3. The analysis method according to claim 1, wherein the data is separation analysis data that represents a magnitude of a quantitative parameter with respect to time.

4. The analysis method according to claim 1, wherein, in the comparison, an entirety of the data shape or a partial data shape that is a part of the data shape is acquired, and the entirety of the data shape or the partial data shape is compared to the standard shape.

5. The analysis method according to claim 4, wherein the partial data shape includes a highest point of the data shape.

6. The analysis method according to claim 2, wherein, in the calculating, the quantitative value of the target component is calculated based on a regression equation obtained in advance, and
the regression equation represents a relationship between a magnification in a quantitative parameter axis direction of the data shape relative to a representative standard shape selected from the group of shapes, versus the quantitative value of the target component.

7. The analysis method according to claim 6, wherein, in the comparison, the magnification in the quantitative parameter axis direction of the data shape relative to the representative standard shape is obtained, and
in the calculating, the quantitative value of the target component is calculated by substituting the magnification in the quantitative parameter axis direction of the data shape into the regression equation.

8. An analysis apparatus for data generated by at least two parameters, the analysis apparatus comprising:
a comparison unit configured to make a comparison between a data shape of a target component in a measurement sample and a standard shape acquired in advance; and
a unit configured to identify the target component in the measurement sample based on the comparison.

9. An analysis apparatus for data generated by at least two parameters, the analysis apparatus comprising:
a comparison unit configured to make a comparison between a data shape of a target component in a measurement sample and a standard shape acquired in advance; and
a quantitative value calculation unit configured to calculate a quantitative value of the target component in the measurement sample based on the comparison,
wherein the standard shape includes a group of shapes of the target component acquired from a plurality of rstandard samples containing the target component at different quantitative values.

10. A non-transitory recording medium storing an analysis program for causing a computer to function as each of the units of the analysis apparatus according to claim 8.

11. A method for generating a standard shape for use in an analysis of data represented by at least two parameters, comprising:
acquiring a group of shapes of a target component from a plurality of standard samples containing the target component at different quantitative values, and
forming the standard shape so as to include the group of shapes of the target component.

12. The analysis method according to claim 2, wherein the data is separation analysis data that represents a magnitude of a quantitative parameter with respect to time.

13. The analysis method according to claim 2, wherein, in the comparison, an entirety of the data shape or a partial data shape that is a part of the data shape is acquired, and the entirety of the data shape or the partial data shape is compared to the standard shape.

14. The analysis method according to claim 13, wherein the partial data shape includes a highest point of the data shape.

15. A non-transitory recording medium storing an analysis program for causing a computer to function as each of the units of the analysis apparatus according to claim 9.
